(19) United States
(12) Patent Application Publication
(10) Pub. No.: US 2002/0193146 A1
(43) Pub. Date: Dec. 19, 2002

(54) Method and apparatus for antenna diversity in a wireless communication system

(76) Inventors: Mark Wallace, Bedford, MA (US); Jay Rod Walton, Westford, MA (US)

Correspondence Address: Sarah Kirkpatrick, Manager, Intellectual Property Administration, QUALCOMM Incorporated, 5775 Morehouse Drive, San Diego, CA, 92121-1714, US

(21) Appl. No.: 09/875,397

(22) Filed: Jun. 6, 2001

(51) Int. Cl. H04M 1/00

(52) U.S. Cl. 455/562; 455/101; 455/272; 375/347

(57) ABSTRACT

Method and apparatus for negotiating a transmission scenario in a mixed mode spectrum wireless communication system capable of both MISO and SISO traffic. The transmitter determines an antenna diversity configuration for a given communication link and applies a transmission scenario. The base station queries the remote station for antenna diversity status. In response to the antenna diversity status information, the base station determines and applies a transmission scenario. In one embodiment, a base station generates composite MIMO transmissions to multiple SISO mobile stations.

### RELATED CO-PENDING APPLICATIONS

The present Application for Patent is related to “METHOD AND SYSTEM FOR INCREASED BANDWIDTH EFFICIENCY IN MULTIPLE INPUT—MULTIPLE OUTPUT CHANNELS” by John Ketchum, having U.S. patent application Ser. No. 09/737,602, filed Jan. 5, 2001, assigned to the assignee hereof and expressly incorporated by reference.

### BACKGROUND

1. Field

The present invention relates to wireless data communication. More particularly, the present invention relates to a novel and improved method and apparatus for antenna diversity in a wireless communication system.

2. Background

To improve the quality of wireless transmissions, communication systems often employ multiple radiating antenna elements at the transmitter to communicate information to a receiver. Multiple antennas are desirable, as wireless communication systems tend to be interference-limited, and the use of multiple antenna elements reduces inter-symbol and co-channel interference introduced during modulation and transmission of radio signals, enhancing the quality of communications. Further, the use of multiple element antenna arrays at both the transmitter and receiver enhances the capacity of multiple-access communication systems.

Each system may employ various antenna configurations, including user terminals having only single antenna capability and other user terminals have multiple antennas. Communications for each type of user are processed differently. There is a need, therefore, for high-quality, efficient communications in a mixed mode system.

### SUMMARY

A method for communication in a wireless communication system, the method includes receiving antenna diversity status information for a first communication link, determining of a configuration of the first communication link in response to the antenna diversity status information, and applying a transmission scenario to the first communication link.

In one aspect, a base station apparatus includes an antenna array, and a diversity controller coupled to the antenna array, operative for determining a transmission scenario based on the configuration of a given communication link.

In an alternate aspect, a base station apparatus includes a control processor for processing computer-readable instructions, and a memory storage device coupled to the control processor, operative to store a plurality of computer-readable instructions. The instructions include a first set of instructions for requesting antenna diversity status of the first communication link, a second set of instructions for determining a first transmission scenario of the first communication link in response to the antenna diversity status, and a third set of instructions for applying the first transmission scenario to the first communication link.

In still another aspect, a wireless communication system includes a base station, having a first receive antenna, a first correlator and a second correlator coupled to the first receive antenna, a second receive antenna, a third correlator and a fourth correlator coupled to the first receive antenna, a first combiner coupled to the first and third correlators, and a second combiner coupled to the second and fourth correlators. According to one embodiment, a first code is applied to the first correlator and a second code, different from the first code, is applied to the second correlator, the first code is applied to the third correlator and the second code is applied to the fourth correlator.

### BRIEF DESCRIPTION OF THE DRAWINGS

FIG. 1 is a wireless communication system.

FIG. 2 is a configuration of transmitter antennas in a wireless communication system.

FIG. 3 is a table of antenna diversity configurations in a wireless communication system.

FIG. 4 is a mixed mode wireless communication system.

FIG. 5 is a mixed mode wireless communication system.

FIG. 6 is a model of a channel between transmitter and receiver in a wireless communication system.

FIG. 7 is model of a channel for a Multiple Input Multiple Output, MIMO, configuration.

FIG. 8 is a wireless communication system employing selection diversity at a receiver.

FIG. 9 is a wireless communication system employing Maximal Ratio Combining, MRC, type selection diversity at a receiver.

FIG. 10 is a wireless communication system configured for transmit diversity transmissions.

FIG. 11 is a wireless communication system configured for MIMO transmissions.

FIG. 12 is a wireless communication system capable of MIMO and diversity transmissions.

FIG. 13 is a flow diagram of a method of mixed mode operation of a forward link in a wireless communication system.

FIG. 14 is a flow diagram of a method of mixed mode operation of a reverse link in a wireless communication system.

FIG. 15 is a wireless communication system employing transmit diversity.

FIG. 16 is a wireless communication system employing transmit diversity and spreading codes.

FIG. 17 is a base station having a distributed antenna system for creating multi-paths in a wireless communication system.

FIG. 18 is a base station having a mixed mode controller.

FIG. 19 is a mixed mode wireless communication system incorporating MIMO mobile stations and SISO mobile stations.

FIG. 20 is a mobile station adapted for operation within a wireless communication system.

### DETAILED DESCRIPTION

The use of multiple element antenna arrays at both the transmitter and receiver is an effective technique for enhancing the capacity of multiple-access systems. Using Multiple Input-Multiple Output, MIMO, the transmitter can send multiple independent data streams on the same carrier frequency to a user. At high Signal to Noise Ratios, SNRs, the increase in throughput approaches N times the throughput of single transmit systems operating with Single Input-Multiple Output, SIMO, or without receive diversity, Single Input-Single Output, SISO, where N=min(Nₜ,Nᵣ), with Nᵣ and Nₜ being the number of receiver and transmitter antennas, respectively.

In some systems it is desirable to support a mixture of user terminal types. For example, terminals designed for voice services only may employ a single antenna for receive and transmit. Other devices may employ a number of receive antennas, and possibly a number of transmit antennas as well. To support mixed mode operation the base station must be equipped with multiple antennas on which to transmit and receive. The table of FIG. 3 gives the matrix of operating modes for terminal traffic including SISO, SIMO, Multiple Input-Single Output, MISO, and MIMO that can be supported by a MIMO capable network.

In multiple access systems it is desirable that all four modes of operation be supported. For performance reasons it is usually desirable to employ diversity techniques (i.e., SIMO and MISO) whenever possible since these schemes typically outperform SISO methods. On the uplink, also referred to as the reverse link, diversity techniques can be supported by placing multiple receive antennas at the base stations. On the downlink however, it implies that some form of transmit diversity be used when transmitting to single receive antenna devices (i.e., MISO). Because MISO operation requires different receiver processing than SISO operation, it is possible that certain systems may have a requirement to also support SISO operation for a fraction of the terminals.

In Time Division Multiple Access, TDMA, and Frequency Division Multiple Access, FDMA, systems it is possible to segregate the SISO downlink traffic from the rest of the traffic by providing those services on separate time slots or frequencies. So, mixed mode operation is relatively easy to accommodate in these systems.

In CDMA systems it is not as easy to isolate SISO traffic from traffic using other modes. In CDMA systems, users are assigned different spreading codes that perform a similar function as frequency sub-channels in the FDMA case or time slots in the TDMA case. In some cases, the spreading codes are designed to be mutually orthogonal so that interference from other users is zero. As long as the channel is non-dispersive (i.e., no resolvable multipath), the orthogonality property holds and users do not interfere with one another. In this case it is possible to use SISO for a user on one code channel and MISO or MIMO for users on other code channels. However, when the channel becomes time dispersive, orthogonality is lost and interference power from other users is no longer zero. Channels become dispersive as a result of multipath signal propagations that differ from one another by more than one spreading chip duration. When propagation paths differ by more than one spreading chip in duration, they can be independently demodulated using a RAKE receiver as is well known in the art and described in detail in U.S. Pat. No. 5,109,390, entitled “Diversity Receiver in a CDMA Cellular Telephone System”, assigned to the assignee of the present invention and hereby expressly incorporated by reference herein. In addition, equalizer receiver structures can also be used to demodulate signals experiencing multipath propagation.

In traditional CDMA systems, a loss in orthogonality on the downlink is not necessarily catastrophic since the signal and interference terms are correlated on each of the delay components. Suppose the channel response is given as H₀(t)=h_{0,0}(t)+h_{0,1}(t−T), where h_{0,0} is the direct path and h_{0,1} is the reflected path between the transmit antenna 0 and the user terminal antenna. Further assume that h_{0,0} and h_{0,1} are not highly correlated. The RAKE receiver is essentially a matched filter in this case, so the average SNR ratio, γ, can be expressed as:

$${γ}_{SISO} = ( \frac{W φ {I}_{o}}{R} ) \cdot [ \frac{α}{η + β {I}_{0}} + \frac{β}{η + α {I}_{0}} ] , \qquad ( 1 )$$

wherein W is the operating bandwidth, R is the data rate, I₀ is the total power of the downlink, φ is the fraction of total power allocated to the user, and η is the thermal noise power. Additionally defined are:

α=E{|h_{0,0}|²} (2)

and

β=E{|h_{0,1}|²} (3)

wherein E{ } signifies expected value. Inspection of this SISO SNR expression of equation (1) shows that even though the direct and reflected paths of the channel destroy orthogonality, they provide a form of implicit diversity. That is, the interference power in the denominator of the first term in brackets, βI₀, is identically correlated with the signal power in the numerator of the second term. A similar relationship exists for the other path. Assuming the data rate and power allocation are matched appropriately, the interference power caused by the delay spread does not significantly contribute to the overall error rate. That is, the primary error event is when both paths fade into the noise.

Now, consider what happens to the SISO receiver when another transmit antenna is used to accommodate users employing MISO and/or MIMO. Using a similar channel model as above for the second transmit antenna results in a channel response of H₁(t)=h_{1,0}(t)+h_{1,1}(t−T), and the SNR at the RAKE receiver output now becomes:

$${γ}_{mixed\_mode} = ( \frac{W φ {I}_{o}}{R} ) \cdot [ \frac{α}{η + β {I}_{0} + {I}_{1}} + \frac{β}{η + α {I}_{0} + {I}_{1}} ] , \qquad ( 4 )$$

Inspection of the SISO SNR expression given in equation (4) shows that the power from transmit antenna 1, I₁, now present an independent fading interference term in the denominator of both terms in the brackets. In this case, the primary error event is the desired signal from antenna 0 fading relative to the interference power emitted from antenna 1. So in mixed mode operation (i.e., one transmitter communicating with a MIMO and/or MISO user and also with a SISO user), the interference power from the additional antennas can seriously degrade the performance of SISO terminals.

In one embodiment, a CDMA system solves this problem using a form of transmit diversity (e.g., MISO) to accommodate single receive antenna users when mixed mode services are offered. Various alternate MISO approaches to solving this problem are described herein.

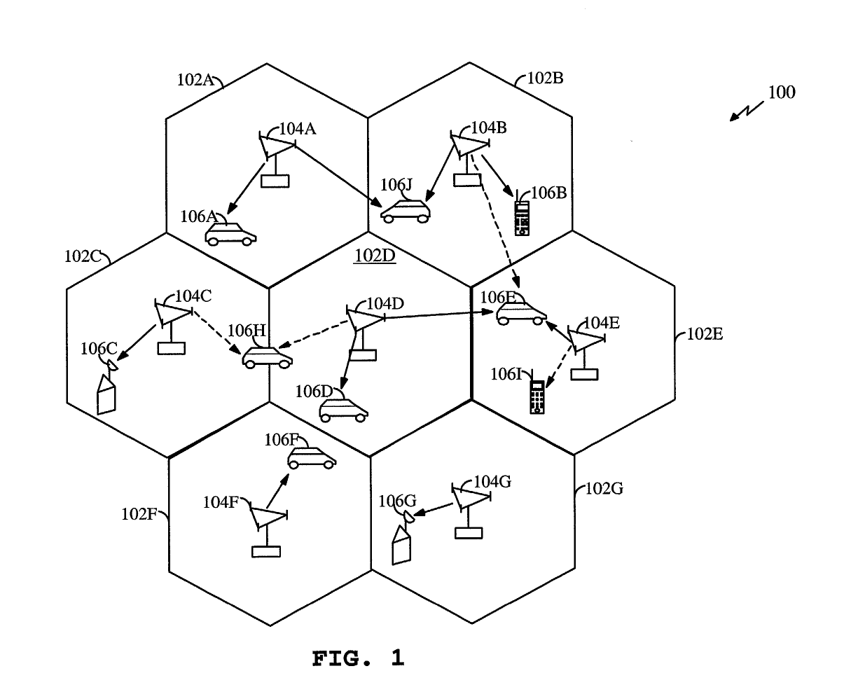

FIG. 1 is a diagram of a communications system 100 that supports a number of users and is capable of implementing at least some aspects and embodiments of the invention. System 100 provides communication for a number of cells 102A through 102G, each of which is serviced by a corresponding base station 104A through 104G, respectively. In the exemplary embodiment, some of base stations 104 have multiple receive antennas and others have only one receive antenna. Similarly, some of base stations 104 have multiple transmit antennas, and others have single transmit antennas. There are no restrictions on the combinations of transmit antennas and receive antennas. Therefore, it is possible for a base station 104 to have multiple transmit antennas and a single receive antenna, or to have multiple receive antennas and a single transmit antenna, or to have both single or multiple transmit and receive antennas.

Terminals 106 in the coverage area may be fixed (i.e., stationary) or mobile. As shown in FIG. 1, various terminals 106 are dispersed throughout the system. Each terminal 106 communicates with at least one and possibly more base stations 104 on the downlink and uplink at any given moment depending on, for example, whether soft handoff is employed or whether the terminal is designed and operated to (concurrently or sequentially) receive multiple transmissions from multiple base stations. Soft handoff in CDMA communications systems is well known in the art and is described in detail in U.S. Pat. No. 5,101,501, entitled “Method and system for providing a Soft Handoff in a CDMA Cellular Telephone System”, which is assigned to the assignee of the present invention and incorporated by reference herein.

The downlink refers to transmission from the base station to the terminal, and the uplink refers to transmission from the terminal to the base station. In the exemplary embodiment, some of terminals 106 have multiple receive antennas and others have only one receive antenna. Similarly, some of terminals 106 have multiple transmit antennas, and others have single transmit antennas. There are no restrictions on the combinations of transmit antennas and receive antennas. Therefore, it is possible for a terminal 106 to have multiple transmit antennas and a single receive antenna or to have multiple receive antennas and a single transmit antenna or to have both single or multiple transmit or receive antennas. In FIG. 1, base station 104A transmits data to terminals 106A and 106J on the downlink, base station 104B transmits data to terminals 106B and 106J, base station 104C transmits data to terminal 106C, and so on.

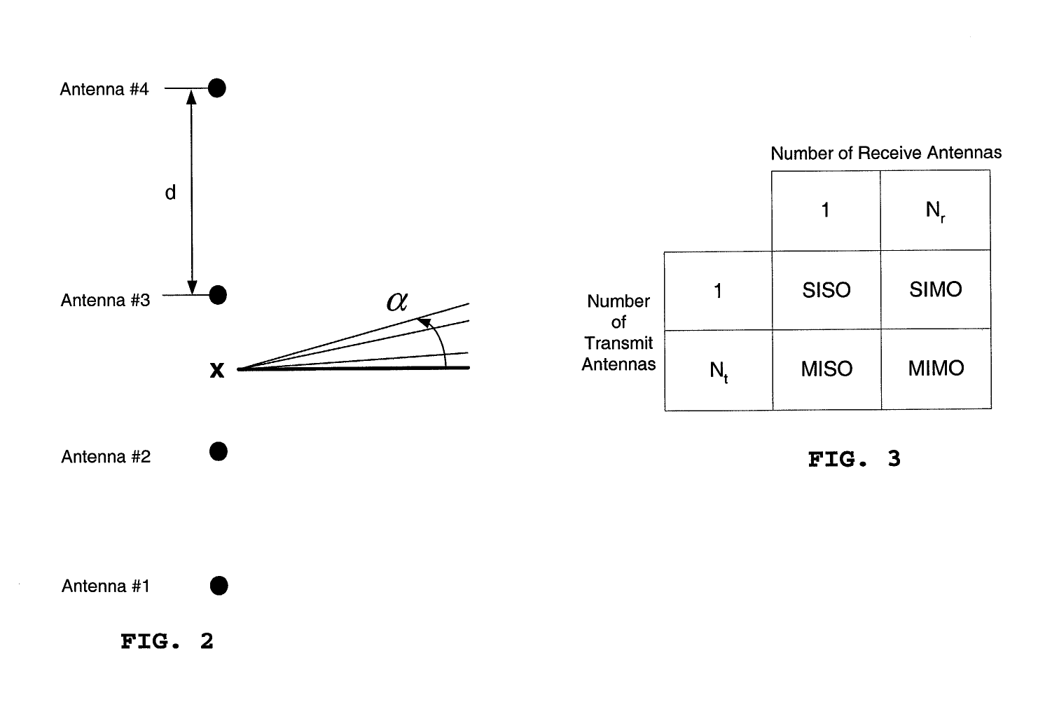

The use of multiple antennas at the transmitter and/or receiver is referred to as antenna diversity. FIG. 2 illustrates a physical configuration of multiple antennas at a transmitter. The four antennas are each spaced at a distance “d” from the next adjacent antenna. The horizontal line gives a reference direction. Angles of transmission are measured with respect to this reference. The angle “α” corresponds to an angle of a propagation path with respect to the reference within a 2-D plane as illustrated. A range of angles with respect to the reference is also illustrated. The position and angle of propagation define the transmission pattern of the antenna configuration. Transmit antenna diversity allows directional antennas to form a directed beam for a specific user or to form multi-path signals having sufficient separation for the receiver to identify the constituent components.

The receiver may also employ antenna diversity. In one embodiment a rake receiver processes multi-path signals in parallel, combining the individual signals to form a composite, stronger signal. For a given communication link, the receiver and/or transmitter may employ some type of antenna diversity.

Diversity reception refers to the combining of multiple signals to improve SNR of a system. Time diversity is used to improve system performance for IS-95 CDMA systems. Generally, buildings and other obstacles in built-up areas scatter the signal. Furthermore, because of the interaction between the several incoming waves, the resultant signal at the antenna is subject to rapid and deep fading. Average signal strength can be 40 to 50 dB below the free-space path loss. Fading is most severe in heavily built-up areas in an urban environment. In these areas, the signal envelope follows a Rayleigh distribution over short distances and a lognormal distribution over large distances.

Diversity reception techniques are used to reduce the effects of fading and improve the reliability of communication without increasing either the transmitter's power or the channel bandwidth.

The basic idea of diversity receptions is that, if two or more independent samples of a signal are taken, these samples will fade in an uncorrelated manner. This means that the probability all the samples being simultaneously below a given level is much lower than the probability of any individual sample being below that level. The probability of M samples all being simultaneously below that level is p^{M}, where p is the probability that a single sample is below that level. Thus, we can see that a signal composed of a suitable combination of the various samples will have much less severe fading properties than any individual sample.

In principle, diversity reception techniques can be applied either at the base station or at mobile station, although each type of application has different problems that must be addressed. Typically, the diversity receiver is used in the base station instead of the mobile station. The cost of the diversity combiner can be high, especially if multiple receivers are required. Also the power output of the mobile station is limited by its battery life. The base station, however, can increase its power output or antenna height to improve coverage to a mobile station. Most diversity systems are implemented in the receiver instead of the transmitter since no extra transmitter power is needed to install the receiver diversity system. Since the path between the mobile station and the base station is assumed to be approximately reciprocal, diversity systems implemented in a mobile station work similarly to those in base station.

A method of resolving multi-path problems uses wide band pseudorandom sequences modulated onto a transmitter using other modulation methods (AM or FM). The pseudorandom sequence has the property that time-shifted versions are almost uncorrelated. Thus, a signal that propagates from transmitter to receiver over multi-path (hence multiple different time delays) can be resolved into separately fading signals by cross-correlating the received signal with multi time-shifted versions of the pseudorandom sequence. In the receiver, the outputs are time shifted and, therefore, must be sent through a delay line before entering the diversity combiner. The receiver is called a RAKE receiver since the block diagram looks like a garden rake.

When the CDMA systems were designed for cellular systems, the inherent wide-bandwidth signals with their orthogonal Walsh functions were natural for implementing a RAKE receiver mitigates the effects of fading and is in part responsible for the claimed 10:1 spectral efficiency improvement of CDMA over analog cellular.

In the CDMA system, the bandwidth (1.25 to 15 MHz) is wider than the coherence bandwidth of the cellular or Personal Communication System, PCS, channel. Thus, when the multipath components are resolved in the receiver, the signals from each tap on the delay line are uncorrelated with each other. The receiver can then combine them using any of the combining schemes. The CDMA system then uses the multipath characteristics of the channel to its advantage to improve the operation of the system.

The combining scheme used governs the performance of the RAKE receiver. An important factor in the receiver design is synchronizing the signals in the receiver to match that of the transmitted signal. Since adjacent cells are also on the same frequency with different time delays on the Walsh codes, the entire CDMA system must be tightly synchronized.

A RAKE receiver uses multiple correlators to separately detect the M strongest multipath components. The relative amplitudes and phases of the multipath components are found by correlating the received waveform with delayed versions of the signal or vice versa. The energy in the multipath components can be recovered effectively by combining the (delay-compensated) multipath components in proportion to their strengths. This combining is a form of diversity and can help reduce fading. Multipath components with relative delays of less than Δt=1/B_{w} cannot be resolved and, if present, contribute to fading; in such cases forward error—correction coding and power control schemes play the dominant role in mitigating the effects of fading.

Denoting the outputs of the M correlators as Z₁, Z₂, . . . , and Z_{M}, and the weights of the corresponding outputs as a₁, a₂, . . . a_{M}, respectively, the composite signal \overline{Z} is given as

$$\overline{Z} = {\sum }_{k = 1}^{M} {a}_{k} \cdot {Z}_{k} .$$

The weighting coefficients are based on the power or the SNR from each correlator output. If the power or SNR is small from a particular correlator, it is assigned a small weighting factor. The weighting coefficients, aₖ, are normalized to the output signal power of the correlator in such a way that the coefficients sum to unity, e.g.,

$${a}_{k} = \frac{{Z}_{k}^{2}}{{\sum }_{k = 1}^{M} {Z}_{k}^{2}} .$$

In CDMA cellular/PCS systems, the forward link (BS to MS) uses a three-finger RAKE receiver, and the reverse link (MS to BS) uses a four-finger RAKE receiver. In the IS-95 CDMA system, the detection and measurement of multipath parameters are performed by a searcher-receiver, which is programmed to compare incoming signals with portions of I- and Q- channel PN codes. Multipath arrivals at the receiver unit manifest themselves as correlation peaks that occur at different times. A peak's magnitude is proportional to the envelope of the path signal. The time of each peak, relative to the first arrival, provides a measurement of the path's delay.

The PN chip rate of 1.2288 Mcps allows for resolution of multipath components at time intervals of 0.814 us. Because all of the base stations use the same I and Q PN codes, differing only in code phase offset, not only multipath components but also other base stations are detected by correlation (in a different search window of arrival times) with the portion of the codes corresponding to the selected base stations. The searcher receiver maintains a table of the stronger multipath components and/or base station signals for possible diversity combining or for handoff purposes. The table includes time of arrival, signal strength, and the corresponding PN code offset.

On the reverse link, the base station's receiver assigned to track a particular mobile transmitter uses the I- and Q-code times of arrival to identify mobile signals from users affiliated with the that base station. Of the mobile signals using the same I- and Q-code offsets, the searcher receiver at the base station can distinguish the desired mobile signal by means of its unique special preamble for that purpose. As the call proceeds, the searcher receiver is able to monitor the strengths of the multipath components from the mobile unit to the base station and to use more than one path through diversity combining.

FIG. 3 illustrates several antenna diversity schemes for a given communication link between a base station and a user terminal or mobile station. A communication link between two transceivers typically includes two directional paths, e.g. Forward Link, FL, from a base station to a user terminal, and Reverse Link, RL, from the user terminal to the base station. Consider one path of a communication link from a transmitter to a receiver. Four possible configuration types for the path are given in FIG. 3: Single Input Single Output, SISO; Single Input Multiple Output, SIMO; Multiple Input Single Output, MISO; and Multiple Input Multiple Output, MIMO. Each configuration type describes one path of a given communication link, wherein the transmitter for one path is the receiver for the other path, and vice versa.

Note that the number of receive antennas, denoted Nr, is not necessarily equal to the number of transmit antennas, denoted Nt, for the transmitter and/or the receiver. Therefore, a RL may have a different configuration from that of the FL. In practice the base station will not typically employ a single transmit antenna, however, with the proliferation of wireless devices, particularly for voice-only capability, single receive antennas at a user terminal are quite common.

As illustrated in FIG. 3, a SISO configuration employs a single transmit antenna at the transmitter and a single receive antenna at the receiver. Further, considering a transmitter with only a single transmit antenna a SIMO configuration employs Nr receive antennas at the receiver, wherein Nr is greater than one, while the transmitter has a single transmit antenna. The use of multiple antennas at the receiver provides antenna diversity for improved reception. Signals received by the multiple antennas at the receiver are then processed according to a predetermined combination technique. For example, a receiver may incorporate a rake receiver mechanism, wherein received signals are processed in parallel, similar to fingers of a rake. Alternate methods may be employed specific to the requirements and constraints of a given system and/or wireless device.

Continuing with FIG. 3, MISO configuration employs Nt transmit antennas at the transmitter, wherein Nt is greater than one, while the receiver has a single receive antenna. Antenna diversity at the transmitter, such as at the base station, provides improved reception by reducing the effects of multipath fading. The use of multiple antennas at the transmitter introduces additional signal paths and thus tends to increase the impact of fading at the receiver. Diversity basically combines multiple replicas of a transmitted signal. The combination of redundant information received over multiple fading channels tends to increase the overall received Signal-to-Noise Ratio (SNR).

A final configuration, MIMO, places multiple antennas at the transmitter and receiver, i.e., Nt×Nr MIMO. The transmitter may send multiple independent data streams on a same carrier frequency to a given user. A MIMO communication link has (Nt×Nr) individual links. At high SNR, the increase in throughput approaches N times the throughput of a single transmit system configured as a SIMO system or a system with no receive diversity, such as a SISO system, wherein N is equal to the minimum number of antennas at the transmitter or receiver, i.e., N=min(Nt,Nr).

In general diversity combining methods at the receiver fall into one of four categories: selection; Maximal Ratio Combining, MRC; equal gain combining; feedback diversity. Diversity combining methods are discussed hereinbelow.

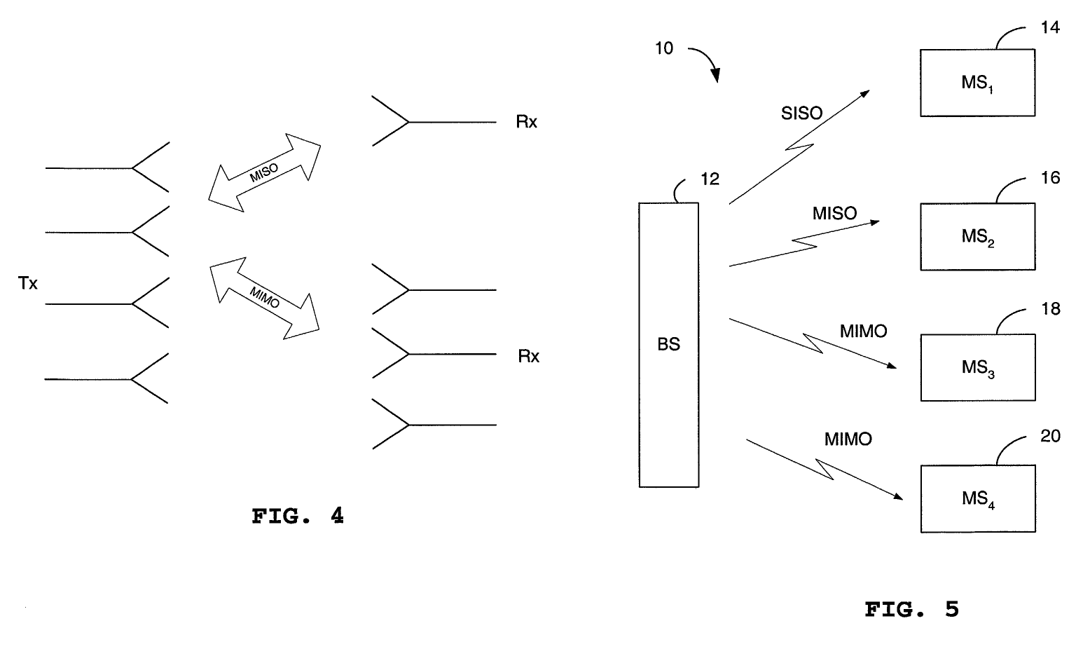

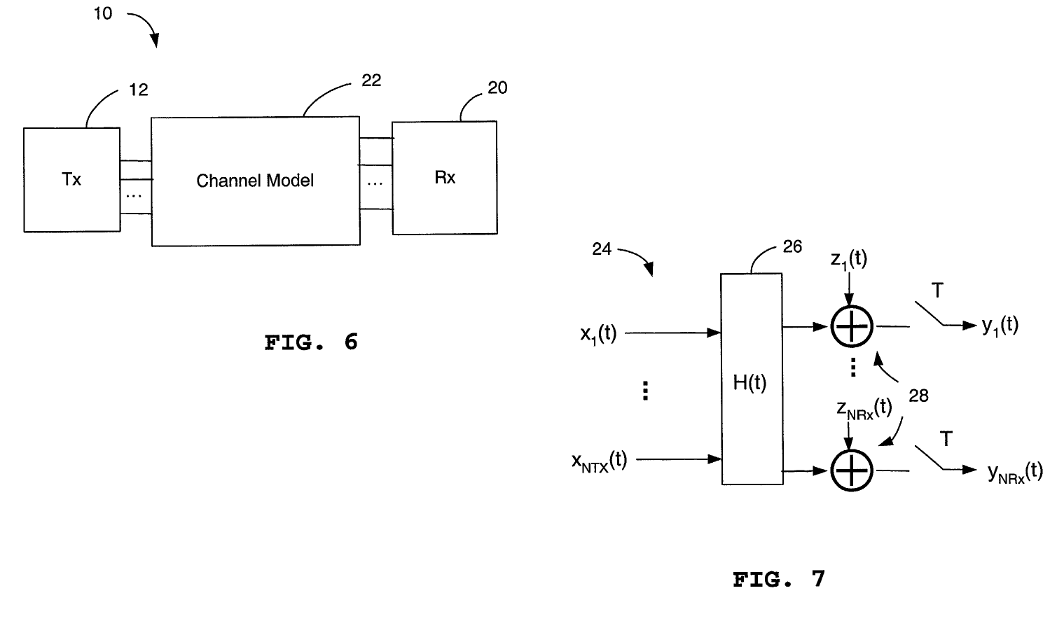

FIG. 4 illustrates configurations for mixed mode wireless communication systems having multiple transmitter Tx antennas. A communication link exists between each transmitter antenna and each receive antenna. Two types of configurations are illustrated for the various paths: MISO and MIMO. As illustrated, the transmitter uses multiple transmit antennas for both links. Note that a multiple access system may include all four of the configurations of FIG. 3. As antenna diversity improves the quality of communications and increases the capacity of a system, most communication links will be MISO and/or MIMO. While antenna diversity is typically assumed at the base station, in a mixed mode system the user terminals may employ a variety of antenna configurations and processing methods. There is a need, therefore, for a base station to identify each type of communication link to each user terminal and process communications accordingly. In other words, a base station may be required to support MISO, MIMO, and SISO configurations.

In Time Division Multiple Access, TDMA, and Frequency Division Multiple Access, FDMA, type systems communications to a user terminal having no receive diversity, i.e. single receive antenna, may be segregated from other traffic. Mixed mode operation is relatively easily accommodated in TDMA and FDMA systems. In a spread spectrum type communication system, such as a Code Division Multiple Access, CDMA, system, users are assigned different spreading codes, similar in function to sub-channels in an FDMA system or time slots in a TDMA system. The “TIA/EIA/IS-2000 Standards for cdma2000 Spread Spectrum Systems” referred to as “the cdma2000 standard,” provides a specification for a CDMA system. Operation of a CDMA system is described in U.S. Pat. No. 4,901,307, entitled “SPREAD SPECTRUM MULTIPLE ACCESS COMMUNICATION SYSTEM USING SATELLITE OR TERRESTRIAL REPEATERS,” and also in U.S. Pat. No. 5,103,459, entitled “SYSTEM AND METHOD FOR GENERATING WAVEFORMS IN A CDMA CELLULAR TELEPHONE SYSTEM,” both assigned to the assignee of the present application for patent and hereby expressly incorporated by reference.

In one embodiment of a CDMA system the spreading codes are designed to be mutually orthogonal so as to eliminate neighbor interference. While the communication channel is non-dispersive the orthogonality property holds and users do not interfere with each other. In a mixed mode system under these conditions, it is possible to communicate on a SISO communication link using one code and also communicates on a MISO or a MIMO communication link using other codes. When the communication channel becomes dispersive, the orthogonality is lost introducing interference power from other users.

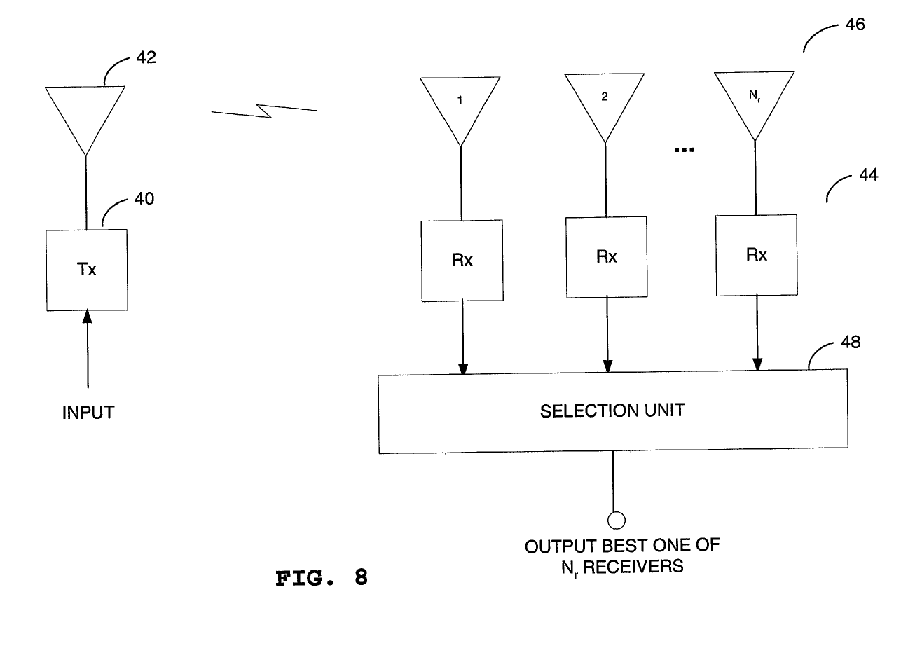

FIG. 5 illustrates one embodiment of a mixed mode system 10 having a base station, BS, 12, and four user terminals or mobile stations, MSs, MS1 14, MS2 16, MS3 18, and MS4 20. A communication link is illustrated between BS 12 and each of the mobile stations 14, 16, 18, 20. The BS 12 has M transmit antennas. Each communication link includes a FL and RL. The FL communication link configurations include a SISO configuration to MS1 14, wherein MS1 14 is a voice-only device restricted to SISO communications. Communications to MS1 14 may be processed using a unique spreading code to isolate the SISO communication, or alternatively may be processed at a different carrier frequency than other traffic from BS 12. The FL communications link with MS2 16 is a MISO configuration, wherein MS2 16 has a single receive antenna. MS2 16 combines the multiple received signals to determine the transmitted information. Any of a variety of methods is typically used for such signal processing. Several combining methods are discussed hereinbelow. The FL communication links with MS3 18 and MS4 20 are each MIMO configurations, wherein MS3 18 has N receive antennas and MS4 20 has M receive antennas. A variety of reception processing methods are available for use at MS3 18 and MS4 20.

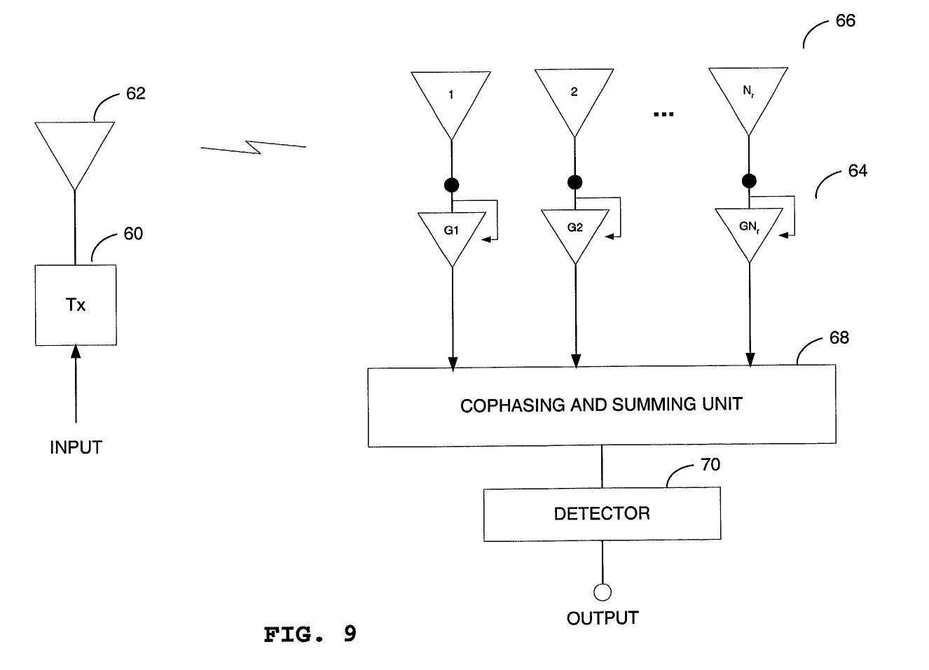

System 10 is a CDMA wireless communication system having a channel model 22 as illustrated in FIG. 6. The channel model 22 is used to model the communication link between BS 12 and MS4 20. A transfer function may be used as the channel model 22, wherein the transfer function is expressed as a set of equations describing the link.

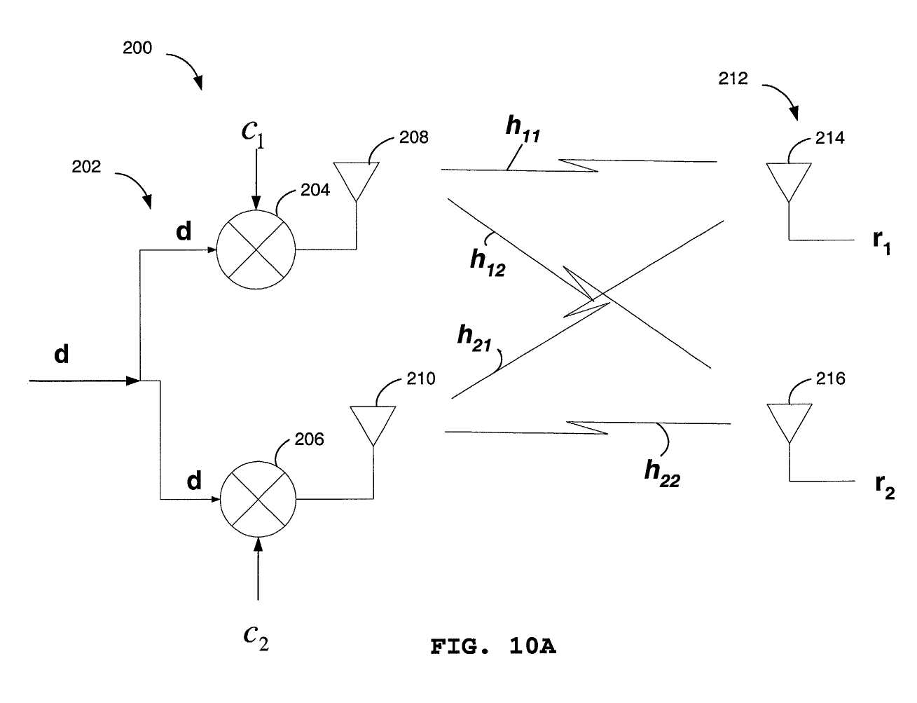

FIG. 7 illustrates a model 24 of a MIMO channel for continuous time having a linear MIMO filter 26 with N_{Tx} inputs and N_{Rx} outputs. The linear MIMO filter 26 is defined by the N_{Tx}×N_{Rx} matrix H(t) comprised of linear functions hᵢⱼ(t),i=1 . . . N_{Tx},j=1 . . . N_{Rx}. Generally, hᵢⱼ(t)i=1 . . . N_{Tx}, j=1 . . . N_{Rx} are unknown linear functions. The linear MIMO filter 26 represents the (N_{Tx}·N_{Rx}) radio channels through which the N_{Tx} transmit signals pass to the N_{Rx} receiver antennas. These radio channels are characterized by their channel impulse responses hᵢⱼ(t),i=1 . . . N_{Tx}, j=1 . . . N_{Rx}. The input signal to the model, \vec{x}(t), is a (N_{Tx}·1) column vector representing the N_{Tx} band-limited transmit signals, and the output signal from the model, \vec{y}(t), is a (N_{Rx}·1) column vector, sampled at t=T,2T, . . . as illustrated by switch T, where the bandwidth of each of the transmitted signals is less or equal to 1/T. The received signals contain additive perturbation signals represented by the (N_{Tx}×1) column vector \vec{z}(t), introduced due to noise or co-channel interference. The additive perturbation signals are added at summation nodes 28. The relation between the input signals \vec{x}(t), the channels H(t), the perturbation \vec{z}(t) and the output signals \vec{y}(t) is given by \vec{y}(t)=H^{T}(t)*\vec{x}(t)+\vec{z}(t), wherein * denotes the convolution. Alternate models may be used to describe a channel.

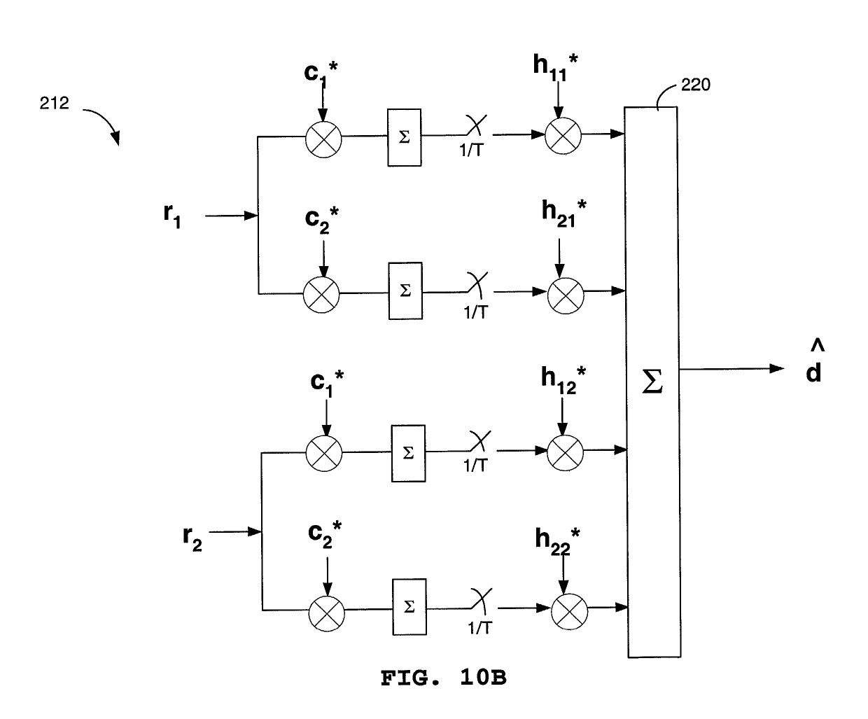

For mixed mode operation of one embodiment, the base station negotiates with user terminals to determine antenna diversity status of the terminal. As discussed hereinabove, there are generally four types of combination processing used at a receiver. Selection diversity is applied at a receiver having multiple antennas, wherein a best signal among the multiple received signals is chosen. FIG. 8 illustrates a communication system employing selection diversity having a transmitter 40 with one transmit antenna 42. The transmitter 40 communicates with a rake receiver 44 having Nr fingers each coupled to an antenna in an antenna array 46. The rake receiver 44 outputs the Nr antenna signals to a selection unit 48. The selection unit may sample the signals and provide the best one as output, wherein the best signal is determined by a quality metric, such as SNR. Alternate metrics may be used based on the system configuration and constraints. The selection diversity operation of FIG. 8 may be employed at the base station or the mobile station.

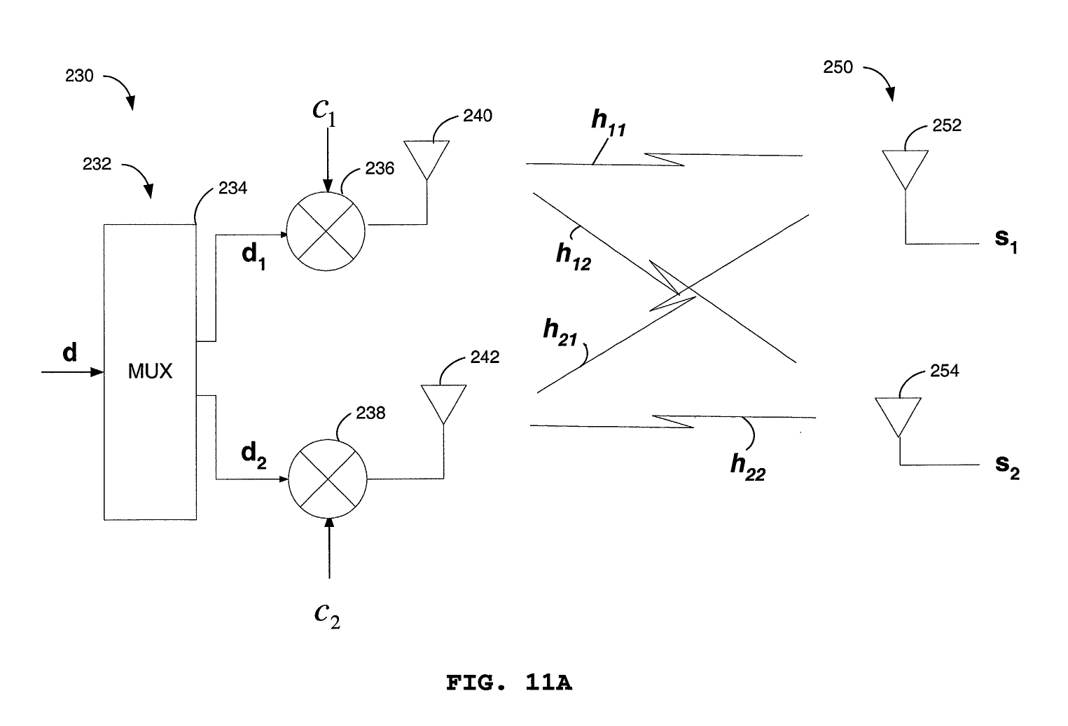

A second method of reception diversity, referred to as MRC, applies weights to each received signal. One embodiment of an MRC system is illustrated in FIG. 9. The system includes a transmitter 60 having a single antenna 62. The receiver has multiple gain amplifiers 64, each coupled to an antenna of antenna array 66. Each received signal is weighted proportionally to the SNR value of the signal, wherein the value of the received signal provides control to the corresponding gain amplifier 64. The weighted values are then summed. The individual signals are cophased by cophasing and summing unit 68 prior to summation. The SNR of the output of the unit 66 is equal to the sum of the individual branch SNRs, wherein the combined SNR varies linearly with Nr, the number of receive antennas. The MRC combination method is commonly used in CDMA systems having rake type receivers. A third method of reception diversity is a modification or simplification of MRC, wherein the gains are set equal to a constant value.

A final method of reception diversity is referred to as feedback diversity, and is similar to selection diversity. The receiver scans received signals to determine a best signal based on predetermined criteria. The signals are scanned in a fixed sequence until one is found above a threshold. This signal is used as long as it is maintained above the threshold. When the selected signal falls below the threshold, the scanning process is performed again.

Given the variety of wireless devices, antenna configurations, and transmission/reception processing methods, as well as the vagaries of individual systems, the base station requires at least some minimum amount of information about the receiver. Returning to FIG. 5, the BS 12 requires antenna diversity status information on initiation of an active communication with each of MSs 14, 16, 18, 20.

A wireless communication system, and a CDMA system specifically, may be operated in a number of different communication modes, with each communication mode employing antenna, frequency, or temporal diversity, or a combination thereof. The communication modes may include, for example, a “diversity” communication mode and a “MIMO” communication mode.

The diversity communication mode employs diversity to improve the reliability of the communication link. In a common application of the diversity communication mode, which is also referred to as a “pure” diversity communication mode, data is transmitted from all available transmit antennas to a recipient receiver system. The pure diversity communications mode may be used in instances where the data rate requirements are low or when the SNR is low, or when both are true.

FIGS. 10A and 10B illustrate a spread spectrum communication system 200 configured for transmit diversity mode operation. Specifically illustrated in FIG. 10A are the transmission paths for the forward link from transmitter 202 to receiver 212. At a transmitter 202, which may be a base station, data for transmission is provided as individual data streams to complex multipliers 204 and 206. A unique code is applied to each of the complex multipliers 204, 206. A first code c₁ is applied to multiplier 204 and a second code c₂ is applied to multiplier 206. At multiplier 204 the signal d is spread by the code c₁ and at multiplier 206 the signal d is spread by code c₂. Each of complex multipliers 204, 206 is then coupled to a transmission antenna 208, 210, respectively. In this way, the signal d is spread by a unique spreading code for each antenna. The antenna 208 transmits one of the spread data signal while the antenna 210 transmits the other spread data signal. The receiver 212 includes two antennas 214, 216.

Four transmission paths are illustrated in FIG. 10A, each having a characteristic function, or signature, represented as hᵢⱼ, wherein i is an index corresponding to the transmit antenna, and j is an index corresponding to the receive antenna. In other words, a path exists for each transmit antenna-receive antenna pair.

The data signal d may be part of a data stream, and may represent any type of transmission information, including low latency transmissions, such as voice communications, and high-speed data transmissions. In one embodiment, the data stream is packetized data, wherein individual data streams are provided to each of multiplier 204, 206. At the receiver, the transmitted data streams are then restored to a pre-transmission sequence. The transmit antennas 208, 210 transmit the spread signals to a receiver 212.

At the receiver illustrated in FIG. 10B, transmitted signals are received at antennas 214, 216. The receiver 212 is configured to process each of the transmission paths between transmit antennas and receive antennas. Therefore, each of the receive antennas 214, 216 is coupled to a despread processing circuitry corresponding to each path.

In the system 200 illustrated in FIG. 10, four paths are provided, each having a signature or transfer function describing the effects of the path or channel on a transmitted signal. The four paths are despread and processed to determine four estimates of the originally transmitted signal. The four estimates are then summed at summation node 220 to determine a composite estimate \hat{d}.

Each of the antennas 214, 216 is coupled to multiple despread units, i.e. complex multipliers. A unique code c₁* is applied to despread the transmit signal that was originally spread by code c₁. A gain is applied to the resultant despread signal, wherein the gain represents the signature of the channel from transmit antenna 204 to receive antenna 214, h₁₁*. The result is an estimate of the signal d as transmitted via antenna 204 and received by antenna 214.

Antenna 214 is coupled to another multiplier for processing the second received signal, wherein a unique code c₂* is applied to despread the signal that was spread by code c₂. A gain is applied to the resultant despread signal, wherein the gain represents the signature of the channel from transmit antenna 206 to receive antenna 214, h₂₁*.

Antenna 216 is configured in a similar manner for processing signals received from transmit antennas. The estimates of each processing path is then provided to summing node 220 to generate the estimate \hat{d}.

Alternate embodiments may include any number of transmit and receive antennas, wherein the number of transmit antennas may not be equal to the number of receive antennas. The receive antennas include processing circuitry corresponding to at least a portion of the transmit antennas or at least a portion of the transmission paths. The MIMO communication mode employs antenna diversity at both ends of the communication link (i.e., multiple transmit antennas and multiple receive antennas) and is generally used to both improve the reliability and increase the capacity of the communications link. The MIMO communication mode may further employ frequency and/or temporal diversity in combination with the antenna diversity.

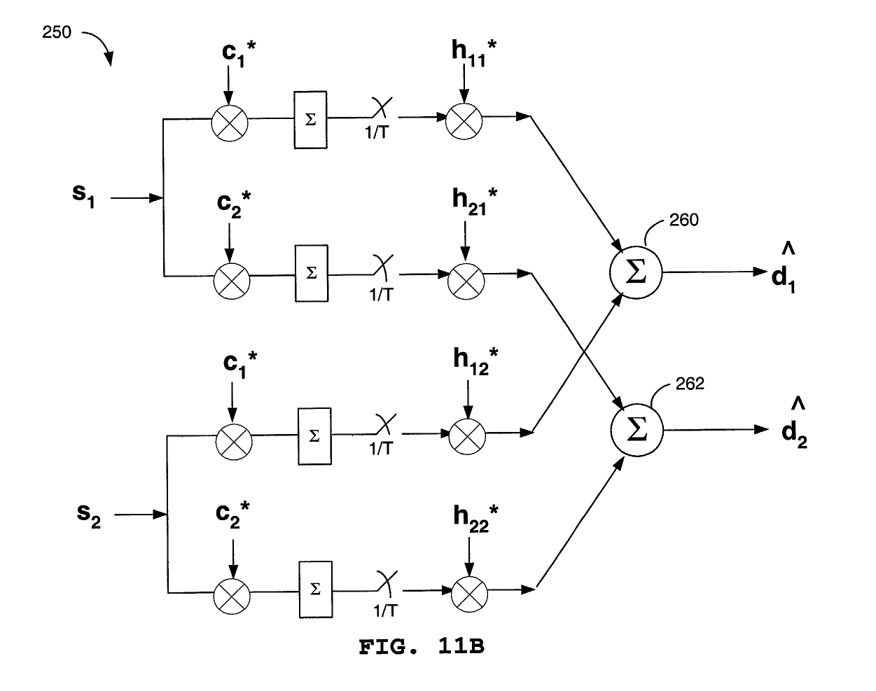

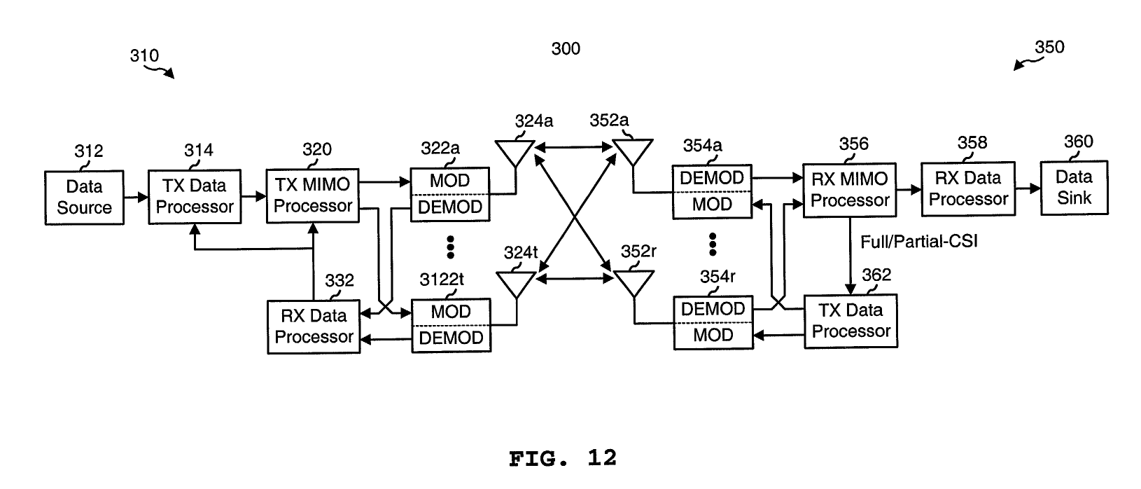

FIGS. 11A and 11B illustrate a wireless system 230 configured for a MIMO mode operation. Specifically illustrated are the transmission paths for the forward link from transmitter 232 to receiver 250. A signal is provided to transmitter 232 as signal d at a first data rate r. The transmitter 232 separates the signal d into multiple portions, one corresponding to each transmit antenna 240, 242. A MUX 234 provides a first portion of signal d to multiplier 236, labeled do, and a second portion of signal d to multiplier 238, labeled d₂. For example, each of the signal portions d₁, and d₂, are provided to multipliers 236, 238, respectively, at a rate of r/2. The multipliers 236, 238 apply spreading codes c₁ and c₂, respectively, to the signals d₁, and d₂, respectively. The multipliers 236, 238 are then coupled to transmit antennas 240, 242.

As illustrated in FIG. 11A, the receiver 250 includes antennas 252, 254, wherein each antenna is coupled to two processing paths. The signal received at antenna 252 is identified as s₁, wherein s₁=h₁₁d₁+h₂₁d₂. The transmission channel or path from transmit antenna 240 to receive antenna 252 is described by h₁₁ and the path from transmit antenna 242 to receive antenna 252 is described by h₂₁. Similarly, the signal received at antenna 254 is identified as s₂, wherein S₂=h₁₂d₁+h₂₂d₂. The transmission channel or path from transmit antenna 240 to receive antenna 254 is described by h₁₂ and the path from transmit antenna 242 to receive antenna 254 is described by h₂₂. The signals s₁ and s₂ are despread using a code c₁* corresponding to code c₁ of the transmitter 232, and a code c₂* corresponding to code c₂ of the transmitter 232. A gain corresponding to each transmission path is applied to each processing path. The results are provided to summing nodes 260 and 262, respectively, to generate estimates \hat{d}₁ and \hat{d}₂. The estimates \hat{d}₁ and \hat{d}₂ may then be demultiplexed to generate an estimate \hat{d} of the original signal d.

Specifically, transmissions sent via the transmission path from transmit antenna 240 to receive antenna 252 are despread using c₁* corresponding to code c₁ and then the gain corresponding to h₁₁ is applied. The result is provided to summing node 260. In a similar way, transmission sent via the transmission path from transmit antenna 240 to receive antenna 254 are despread using c₁* corresponding to code c₁ and then the gain corresponding to h₁₂ is applied. The result is provided to summing node 260. In this way, the output of summing node 260 is a composite estimate of transmissions from transmit antenna 240.

Transmissions from transmit antenna 242 are processed in a similar manner. Transmissions sent via the transmission path from transmit antenna 242 to receive antenna 252 are despread using c₂* corresponding to code c₂ and then the gain corresponding to h₂₁ is applied. The result is provided to summing node 262. In a similar way, transmission sent via the transmission path from transmit antenna 242 to receive antenna 254 are despread using c₂* corresponding to code c₂ and then the gain corresponding to h₂₂ is applied. The result is provided to summing node 262. In this way, the output of summing node 262 is a composite estimate of transmissions from transmit antenna 242.

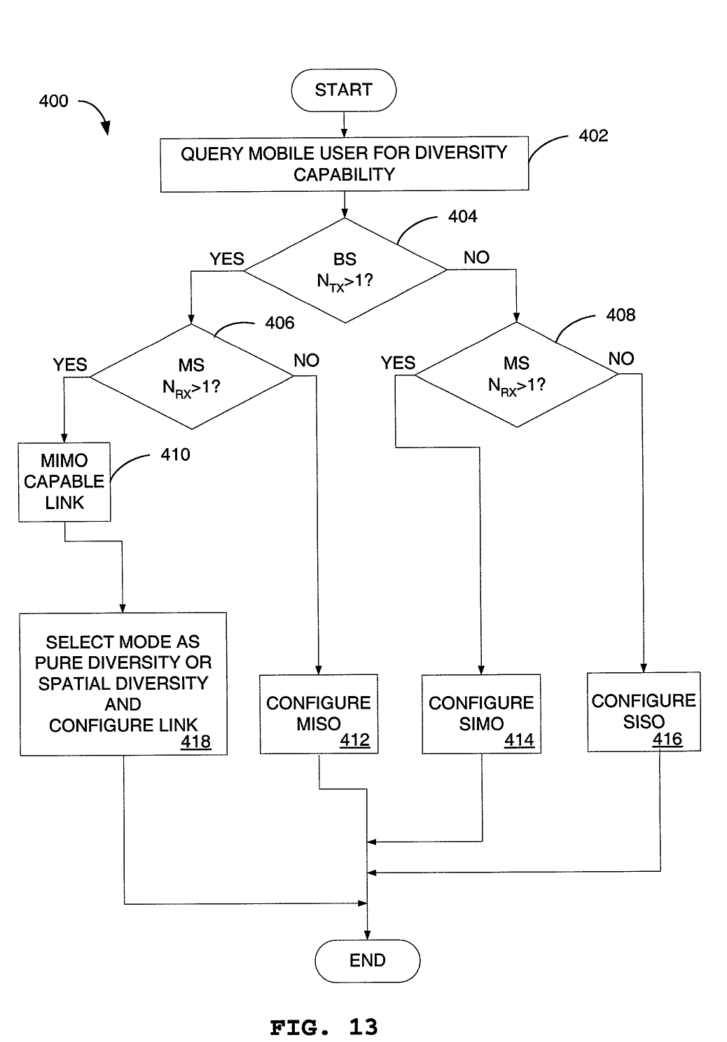

A detailed illustration of a wireless communication system 300 is illustrated in FIG. 12. System 300 may be operated to transmit data via a number of transmission channels. A MIMO channel may be decomposed into NC independent channels, with NC≦min {NT, NR}. Each of the NC independent channels is also referred to as a spatial subchannel of the MIMO channel. For a MIMO system, there may be only one frequency subchannel and each spatial subchannel may be referred to as a “transmission channel”.

A MIMO system can provide improved performance if the additional dimensionalities created by the multiple transmit and receive antennas are utilized. While this does not necessarily require knowledge of CSI at the transmitter, increased system efficiency and performance are possible when the transmitter is equipped with CSI, which is descriptive of the transmission characteristics from the transmit antennas to the receive antennas. CSI may be categorized as either “full CSI” or “partial CSI”.

Full CSI includes sufficient wideband characterization (e.g., the amplitude and phase) of the propagation path between each transmit-receive antenna pair in the NT×NR MIMO matrix. Full-CSI processing implies that (1) the channel characterization is available at both the transmitter and receiver, (2) the transmitter computes eigenmodes for the MIMO channel (described below), determines modulation symbols to be transmitted on the eigenmodes, linearly preconditions (filters) the modulation symbols, and transmits the preconditioned modulation symbols, and (3) the receiver performs a complementary processing (e.g., spatial matched filter) of the linear transmit processing based on the channel characterization to compute the NC spatial matched filter coefficients needed for each transmission channel (i.e., each eigenmode). Full-CSI processing further entails processing the data (e.g., selecting the proper coding and modulation schemes) for each transmission channel based on the channel's eigenvalues (described below) to derive the modulation symbols.

Partial CSI may include, for example, the signal-to-noise-plus-interference (SNR) of the transmission channels (i.e., the SNR for each spatial subchannel for a MIMO system without OFDM, or the SNR for each frequency subchannel of each spatial subchannel for a MIMO system with OFDM). Partial-CSI processing may imply processing the data (e.g., selecting the proper coding and modulation schemes) for each transmission channel based on the channel's SNR.

FIG. 12 is a diagram of a multiple-input multiple-output (MIMO) communication system 300 capable of implementing various aspects and embodiments of the invention. System 300 includes a first system 310 in communication with a second system 350. System 300 can be operated to employ a combination of antenna, frequency, and temporal diversity (described below) to increase spectral efficiency, improve performance, and enhance flexibility. In an aspect, system 350 can be operated to determine the characteristics of the communication link and to report channel state information (CSI) back to system 310, and system 310 can be operated to adjust the processing (e.g., encoding and modulation) of data to be transmitted based on the reported CSI.

Within system 310, a data source 312 provides data (i.e., information bits) to a transmit (TX) data processor 314, which encodes the data in accordance with a particular encoding scheme, interleaves (i.e., reorders) the encoded data based on a particular interleaving scheme, and maps the interleaved bits into modulation symbols for one or more transmission channels used for transmitting the data. The encoding increases the reliability of the data transmission. The interleaving provides time diversity for the coded bits, permits the data to be transmitted based on an average signal-to-noise-plus-interference (SNR) for the transmission channels used for the data transmission, combats fading, and further removes correlation between coded bits used to form each modulation symbol. The interleaving may further provide frequency diversity if the coded bits are transmitted over multiple frequency subchannels. In accordance with an aspect of the invention, the encoding, interleaving, and symbol mapping (or a combination thereof) are performed based on the full or partial CSI available to system 310, as indicated in FIG. 12.

The encoding, interleaving, and symbol mapping at transmitter system 310 can be performed based on numerous schemes. One specific scheme is described in U.S. patent application Ser. No. 09/776,073, entitled “CODING SCHEME FOR A WIRELESS COMMUNICATION SYSTEM,” filed Feb. 1, 2001, assigned to the assignee of the present application and incorporated herein by reference.

Referring to FIG. 12, a TX MIMO processor 320 receives and processes the modulation symbols from TX data processor 314 to provide symbols suitable for transmission over the MIMO channel. The processing performed by TX MIMO processor 320 is dependent on whether full or partial CSI processing is employed, and is described in further detail below.

For full-CSI processing, TX MIMO processor 320 may demultiplex and precondition the modulation symbols. And for partial-CSI processing, TX MIMO processor 320 may simply demultiplex the modulation symbols. The full and partial-CSI MIMO processing is described in further detail below. For a MIMO system employing full-CSI processing, TX MIMO processor 320 provides a stream of preconditioned modulation symbols for each transmit antenna, one preconditioned modulation symbol per time slot. Each preconditioned modulation symbol is a linear (and weighted) combination of NC modulation symbols at a given time slot for the NC spatial subchannels, as described in further detail below. For a MIMO system employing partial-CSI processing, TX MIMO processor 320 provides a stream of modulation symbols for each transmit antenna, one modulation symbol per time slot. For all cases described above, each stream of (either unconditioned or preconditioned) modulation symbols or modulation symbol vectors is received and modulated by a respective modulator (MOD) 322, and transmitted via an associated antenna 324.

In the embodiment shown in FIG. 12, receiver system 350 includes a number of receive antennas 352 that receive the transmitted signals and provide the received signals to respective demodulators (DEMOD) 354. Each demodulator 354 performs processing complementary to that performed at modulator 122. The demodulated symbols from all demodulators 354 are provided to a receive (RX) MIMO processor 356 and processed in a manner described below. The received modulation symbols for the transmission channels are then provided to a RX data processor 358, which performs processing complementary to that performed by TX data processor 314. In a specific design, RX data processor 358 provides bit values indicative of the received modulation symbols, deinterleaves the bit values, and decodes the deinterleaved values to generate decoded bits, which are then provided to a data sink 360. The received symbol de-mapping, deinterleaving, and decoding are complementary to the symbol mapping, interleaving, and encoding performed at transmitter system 310. The processing by receiver system 350 is described in further detail below.

The spatial subchannels of a MIMO system typically experience different link conditions (e.g., different fading and multipath effects) and may achieve different SNR. Consequently, the capacity of the transmission channels may be different from channel to channel. This capacity may be quantified by the information bit rate (i.e., the number of information bits per modulation symbol) that may be transmitted on each transmission channel for a particular level of performance. Moreover, the link conditions typically vary with time. As a result, the supported information bit rates for the transmission channels also vary with time. To more fully utilize the capacity of the transmission channels, CSI descriptive of the link conditions may be determined (typically at the receiver unit) and provided to the transmitter unit so that the processing can be adjusted (or adapted) accordingly.

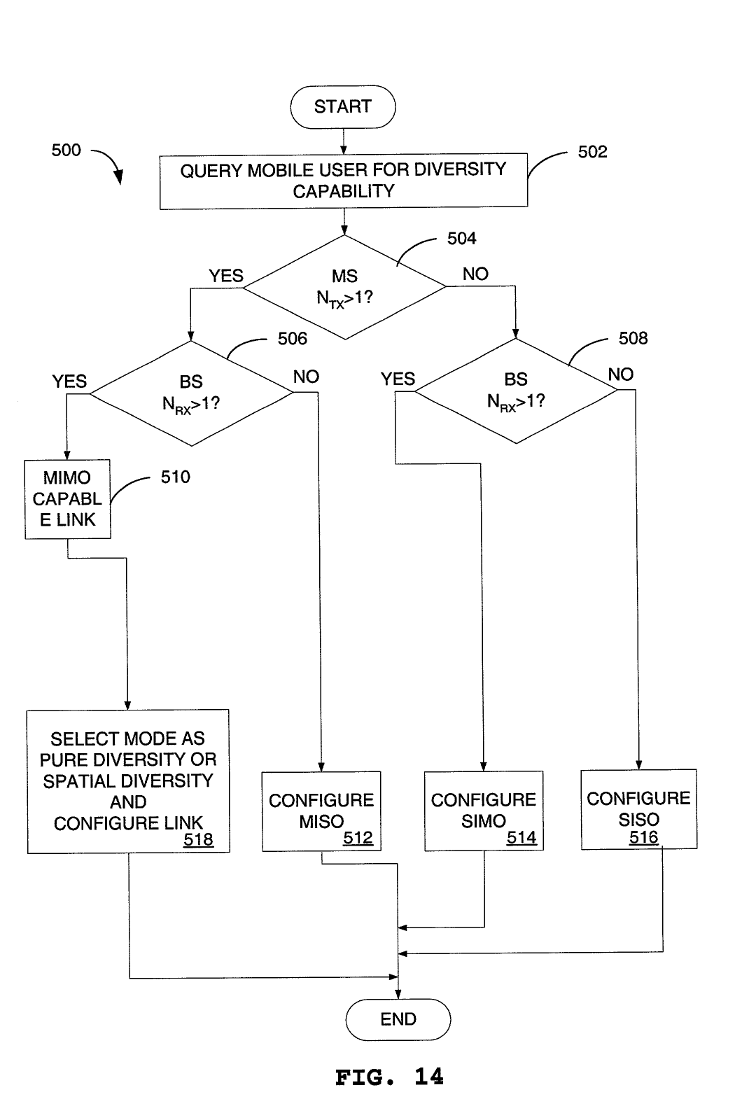

For a mixed mode system, each participant will typically require information regarding the configuration and operating mode of each communication link. FIG. 13 illustrates a method 400 of negotiation for the FL, wherein the negotiation is performed at the base station. The process starts with a query to the mobile user to determine diversity capability information at step 402. The diversity capability for the FL includes the number of receive antennas used at the mobile station. Additionally, the base station may require information about the type of combining used for multiple receive antennas. The base station may also request information regarding the channel quality of given link within a same query. The base station receives the information from the mobile station and begins determining the appropriate configuration and processing for the FL. If the base station has a single transmit antenna, as determined at decision diamond 404, processing proceeds to decision diamond 408 to determine if the mobile user has a single receive antenna or multiple receive antennas. For a FL employing a single transmit antenna and a single receive antenna the system is configured for SISO mode operation at step 416. SISO mode indicates that only a single transmission stream is transmitted from one antenna at the base station to one antenna at the receiver.

If the base station determines that the mobile station has multiple receive antennas at decision diamond 408, the process continues to step 414 to configure the FL as a SIMO link. Typically SIMO operation implies that the receiver is able to operate at a lower Eb/No for higher data rates. In one embodiment, the SIMO link configuration requires no further modification of the transmitter but rather is similar to SISO when considered from the transmitter. In an alternate embodiment, the SIMO is capable of increased data rate, and therefore, the transmitter received feedback from the intended receiver indicating the requested data rate. The transmitter then adjusts for the requested data rate, such as by adjusting modulation, coding, etc. Such adjustment of the transmitter in response to feedback from the receiver is considered partial CSI operation. In one embodiment, the feedback information is provided to the base station via a real-time feedback channel rather than being set up on initiation of a call. Returning to decision diamond 404, if the base station has multiple transmit antennas, the processing continues to decision diamond 406 to determine if the mobile user has multiple receive antennas. If the mobile station has a single receive antenna the base station configures the link as MISO at step 412, else if the mobile station has multiple receive antennas the base station identifies the link as MIMO at step 410. Processing then continues to step 418 to determine the particular mode capability of the receiver, i.e., spatial diversity or pure diversity. The base station then configures the FL accordingly. A variety of indicators may be implemented to determine the MIMO mode of operation.

In one embodiment, the base station determines the C/I of the FL to measure link quality. The mobile station may be queried to provide an indication of link quality, such as C/I of signals received from the base station on the FL. The base station compares a link quality measurement against a predetermined threshold value. If the link quality is poor antenna diversity is used to transmit a same data signal from multiple antennas. Note that in poor link quality cases, the use of both transmit and receive diversity provides an optimal solution. Such a condition could still be viewed as a MIMO link, wherein the two basic types of MIMO links are: pure diversity, i.e., both transmit and receive diversity; and spatial multiplexing, i.e., parallel channels. If the link quality is good, spatial diversity is used, else pure diversity is applied.

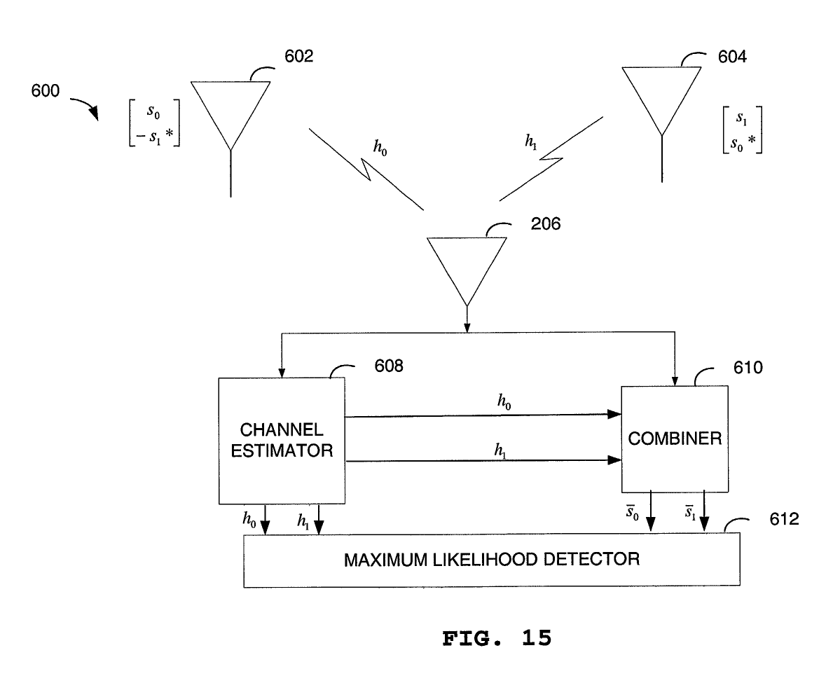

FIG. 14 illustrates a corresponding method 500 of negotiation for the RL, wherein the negotiation is performed at the base station. The process starts with a query to the mobile user to determine diversity capability information at step 502. The diversity capability for the RL includes the number of transmit antennas used at the mobile station. Additionally, the base station may require information about the type of signal transmission used for transmit antenna(s). The base station may also request information regarding the channel quality of given link within a same query. The base station receives the information from the mobile station and begins determining the appropriate configuration and processing for the RL. If the mobile station has a single transmit antenna, as determined at decision diamond 504, processing proceeds to decision diamond 508 to determine if the base station has a single receive antenna or multiple receive antennas. For an RL employing a single transmit antenna and a single receive antenna the system is configured for SISO mode operation at step 516. SISO mode indicates that only a single transmission stream is transmitted from one antenna at the mobile station to one antenna at the base station.

If the base station has multiple receive antennas at decision diamond 508, the process continues to step 514 to configure the RL as a SIMO link (again, nothing special needs to be done over SISO). Further processing, described hereinbelow, verifies the quality of the link to determine an appropriate configuration.

Returning to decision diamond 504, if the mobile station has multiple transmit antennas, the processing continues to decision diamond 506 to determine if the base station has multiple receive antennas. If the base station has a single receive antenna the process configures the link as MISO at step 512, else if the base station has multiple receive antennas the process identifies the link as MIMO capable at step 510. Processing continues to step 518 to select a mode of operation as spatial diversity or pure diversity. As described hereinabove, the decision may be made in response to a variety of indicators.

In a mixed mode system, the base station configures the system for the appropriate communication for each link. The base station may also provide instructions to the remote station indicating the type of reception processing to apply. MIMO processing can spread signals for each individual communication link with a unique spreading code, but transmits to all links on all antenna elements. A variety of methods are available for SO processing, i.e., MISO and/or SISO processing. One method using two transmit antennas is described in “A Simple Transmit Diversity Technique for Wireless Communications” by Siavash M. Alamouti, IEEE JOURNAL ON SELECT AREAS IN COMMUNICATIONS, VOL. 16, NO. 8, OCTOBER 1998, pp. 1451-1458, which is hereby expressly incorporated by reference. A transmit diversity scheme is applied to a configuration of two transmit antennas and one receive antenna. The receive antenna employs an MRC type reception diversity method.

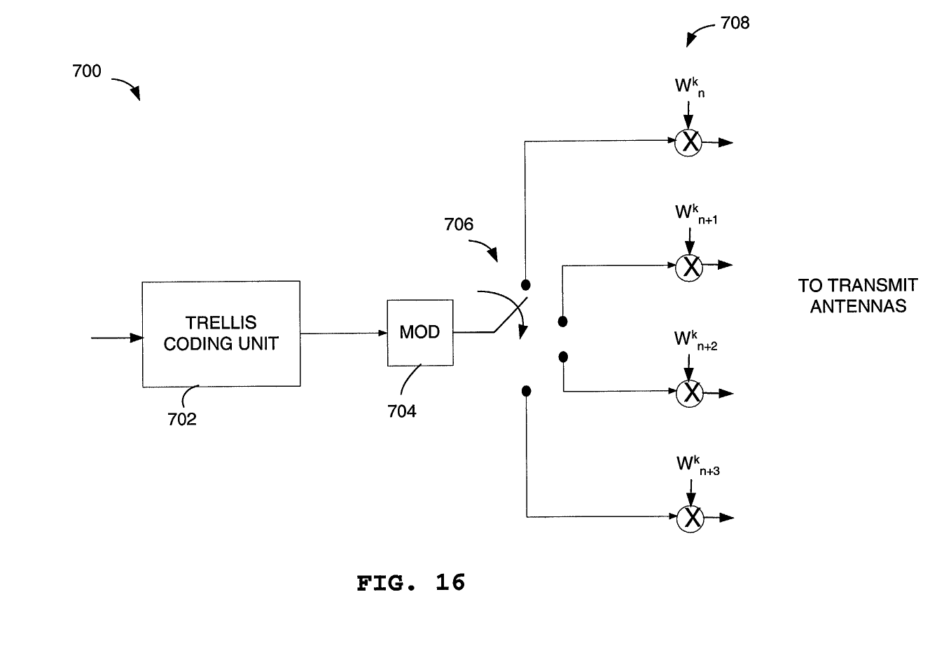

One embodiment of a system using this method is illustrated in FIG. 15. A system 600 includes transmit antennas 602, 604 in communication with receive antenna 606. Receive antenna 606 is coupled to channel estimator 608 and to combiner 610, which are each coupled to maximum likelihood detector 612. Operation is defined by the encoding and transmission sequence of information symbols at the transmitter, the combining scheme at the receiver, and the decision rule for the maximum likelihood detector. Signals are transmitted from antennas 602, 604 in the order indicated.

The antennas 602 and 604 create transmit vectors as illustrated in FIG. 15. At a first time antenna 602 transmits s0 while antenna 604 transmits s1. At a second time antenna 602 transmits −s1* while antenna 604 transmits s0*, wherein * denotes the complex conjugate operation. The channel at a time t is then modeled by h₀=α₀θ^{jθ}^{₀} and h₁=α₁θ^{jθ}^{₁}.

The channel estimator 608 provides h₀ and h₁ to combiner 610 and to maximum likelihood detector 612. From the values of h₀ and h₁, the combiner 610 forms two combined signals \overline{s}₀ and \overline{s}₁ to provide to the maximum likelihood detector 612. The received signals at the channel estimator 608 and combiner 610 are given as r₀=h₀s₀+h₁s₁+n₀, and r₁=−h₀s₁*+h₁s₀*+n₁, wherein n₀ and n₁ represent injected noise terms for each path. Noise injection may be introduced between receive antenna 606 and channel estimator 608. The first signal \overline{s}₀ is calculated as h₀*·r₀+h₁·r₁*, and the second signal \overline{s}₁ is calculated as h₁*·r₀−h₀·r₁*.

As illustrated in FIG. 15, the channel estimates h₀ and h₁ and the signals \overline{s}₀ and \overline{s}₁ are provided to the maximum likelihood detector 612. A selection decision rule is applied to the signals \overline{s}₀ and \overline{s}₁ by maximum likelihood detector 612. With Nt=2 and Nr=M, the configuration and method provides diversity order of 2M, i.e. 2M communication links.

The system 600 of FIG. 15 may be extended to incorporate multiple receive antennas, wherein channel estimation is made for each communication link from a transmitter to a receiver. The channel estimates are then provided to a combiner, wherein the selection criteria is applied to the communication links.

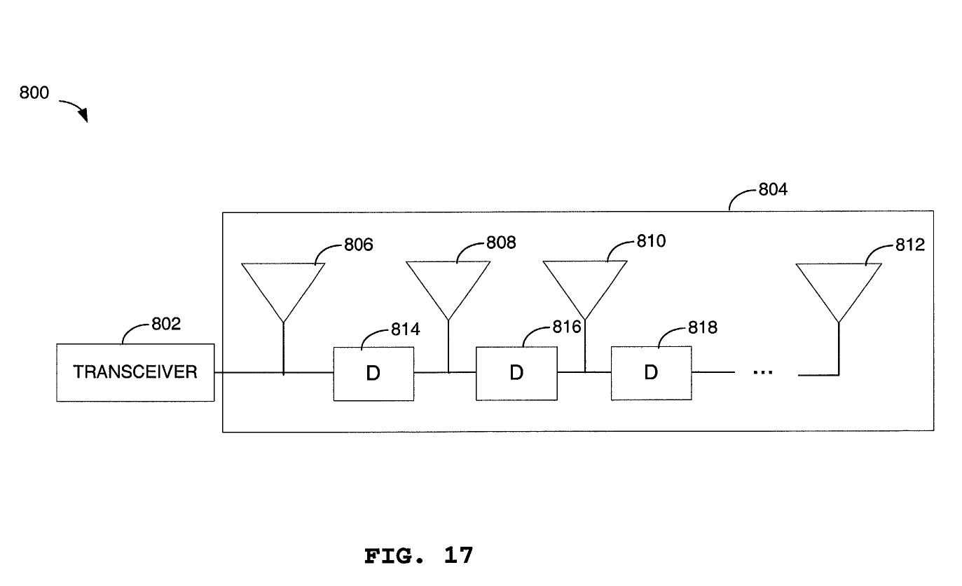

Further, operation of the system of FIG. 15 may be extended to employ a combination of Walsh functions. FIG. 16 illustrates a non-Channel State Information, or non-CSI, type transmitter modem architecture 700 according to one embodiment. A non-CSI modem does not rely on substantial channel state information at the transmitter. The architecture establishes orthogonality among the signals transmitted on multiple transmit antennas by applying Walsh functions to the transmit signals. The transmit orthogonality provided by the Walsh functions can be used to increase bandwidth efficiency by transmitting distinct transmit signal symbols on each antenna. As illustrated in FIG. 16, modem 700 includes a trellis coding unit 702 coupled to a modulator 704, such as a Quadrature Amplitude Modulator. Alternate embodiments may use an alternate type of modulator. The modulated signal is provided to one of multiple antennas (not shown) by way of a switch 706. Each antenna is coupled to a corresponding multiplier 708. The signals are routed to multipliers 708 for application of a unique Walsh code. The switch 706 coupled the output of the modulator 704 to each of multipliers 708, and thus antennas, one at a time.

The modem architecture of FIG. 16 increases of the efficiency of the transmission coding and reception processing of FIG. 15. As an example, consider the transmission of two symbols, denoted A and B. The transmitter creates two transmit vectors x₁=[A B*]^{T} and x₂=[B−A*]^{T}. A different Walsh code is applied to each vector. The elements of the two vectors are then transmitted sequentially on the two antennas, respectively. Consider a configuration as illustrated in FIG. 15 having two transmit antennas and one receive antenna. The receiver may construct estimates of the two transmitted symbols applying the appropriate Walsh codes.

In an alternate embodiment, each of the multipliers 708 is coupled directly to QAM 704 without the switch 706. The transmit signal symbols are repeated across the transmit antennas, wherein each symbol is spread with a different Walsh sequence at each antenna. The resulting orthogonality may be used to establish full transmit diversity across all transmit antennas.

An alternate method of diversity processing is detailed in “A Novel Space-Time Spreading Scheme for Wireless CDMA Systems,” by B. M. Hochwald, et al., Thirty-seventh Annual Allerton Conference on Communication, Control and Computing, Sep. 22-24, 1999, pp. 1284-1293, which is expressly incorporated herein by reference. Transmit diversity at the base station is enhanced by space-time spreading of transmit signals. According to one embodiment, this method specifies the form of transmit signals and the type of coding. Each transmit signal is spread across different antenna elements. For the case of two transmit antennas and one receive antenna, two spreading codes are used. Both spreading codes are applied to both transmit symbols. The transmitted signals are given as t₁=(1/\sqrt{2})(b₁c₁+b₂c₂) and t₂=(1/\sqrt{2})(b₂c₁−b₁c₂), wherein b₁ and b₂ are data symbols, and c₁ and c₂ are spreading codes. The receiver uses the codes c₁ and c₂ to despread the received signals.

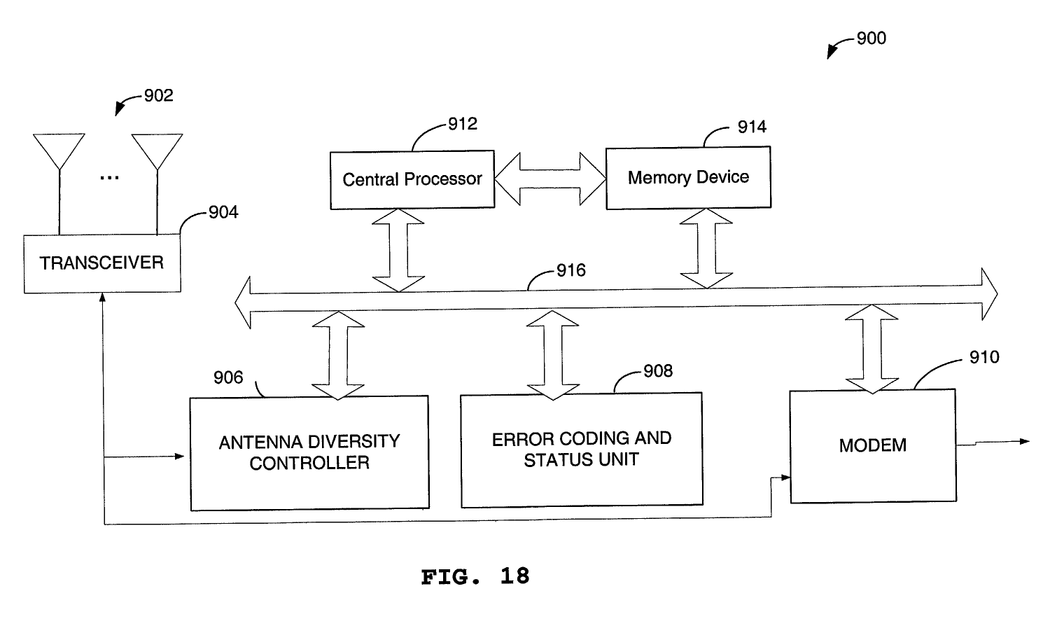

Still another method of antenna diversity is disclosed in U.S. Pat. No. 5,280,472, “CDMA MIOCROCELLULAR TELEPHONE SYSTEM AND DISTRIBUTED ANTENNA SYSTEM THEREFOR,” by Klein S. Gilhousen, issued Jan. 18, 1994, assigned to the assignee hereof and hereby expressly incorporated by reference. A system 800 as illustrated in FIG. 17 having a distributed antenna architecture communicates with mobile users in a CDMA communication system. The mobile users may employ any of a variety of antenna configurations. The system 800 includes a transceiver which receives an encoded signal for transmission and performs frequency conversion of the encoded signal to generate a Radio Frequency, RF, signal. The transceiver 802 provides the RF signal to a distributed antenna system 804 having antenna elements 806, 808, 810, . . . , 812 coupled in series. Delay elements 814, 816, 818, . . . are disposed between adjacent antenna elements 806, 808, 810, . . . , 812. The delay elements 814, 816, 818, . . . provide a predetermined delay (typically greater than 1 chip) to signals transmitted from each of antennas 806, 808, 810, . . . , 812. The delayed signals provide multi-paths which facilitate signal diversity for enhanced system performance.

Alternate embodiments may provide transmit diversity and/or reception diversity according to a variety of configurations and methods. In each of these situations, the base station determines the configuration and requirements of each communication link. The base station may require additional information from a given mobile user, and similarly, may need to transmit specific processing information to one or all mobile users. The base station may select among a variety of transmission scenarios based upon constraints of a given communication link or some other criterion. In one embodiment, the base station determines the transmission scenario in response to quality of the communication link channel. An alternate embodiment seeks to achieve a desired signal error rate.

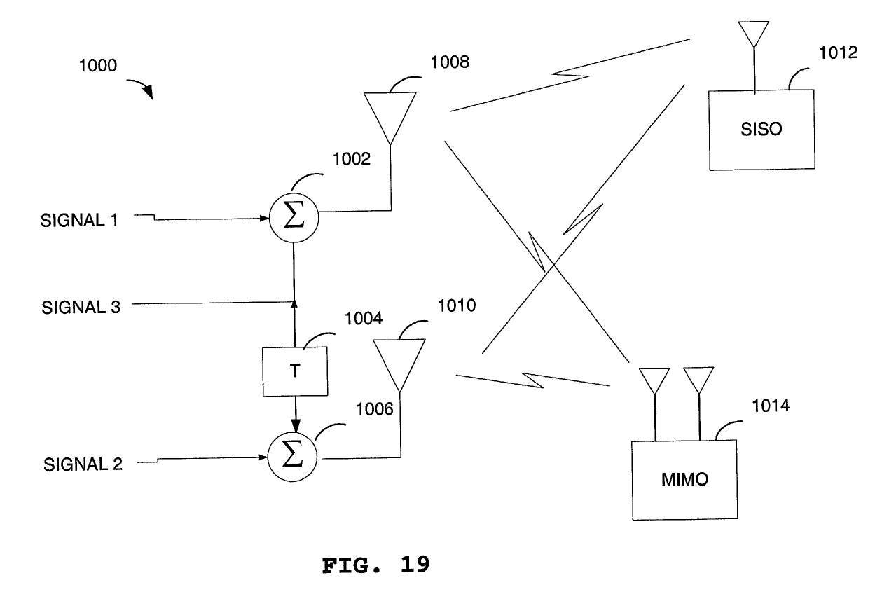

FIG. 18 illustrates base station 900 according to one embodiment having multiple antennas 902, including multiple transmit and receive antennas. Note that FIG. 18 circuitry may be applied to a remote station as well. Alternate configurations may employ separate receive antennas and transmit antennas. As illustrated, a communication bus 916 provides interface within the base station 900 for the central processor 912, the memory device 914, the antenna diversity controller 906, the modem 910 and the error coding and status unit 908. The transceiver 904 coupled to antennas 902 prepares signals for transmission. The transceiver 904 is coupled to antenna diversity controller 906 and modem 910.

The base station 900 determines a transmission scenario on initiation of each communication link. Initiation refers to the start of a communication, including, but not limited to, response to a paging message from the base station, or a request for a communication from a mobile user. Within the base station 900, diversity control decisions are processed by central processor 912 according to computer-readable instructions stored in the memory device 914. Diversity control instructions may be stored in memory device 914 and/or antenna diversity controller 906. Decision criteria, such as used for maximum likelihood decisions, may be stored in memory device 914 and/or antenna diversity controller 906, wherein the decision criteria may be dynamically adjusted in response to the communication environment, etc.

For a given communication link, the antenna diversity controller 906 determines the type of configuration and processing, i.e. transmission scenario. For MIMO configurations, the antenna diversity controller 906 applies a common transmission scenario to each of the multiple transmit antennas 902. In one embodiment, a default scenario is used, while in alternate embodiments, the scenario is selected from multiple options.

The base station 900 performs the methods 400 and 500 of FIGS. 13 and 14, respectively, to determine an appropriate transmission scenario. Basically, according to one embodiment, the method extracts antenna diversity status information from the other participant to a communication. The information is processed to determine an appropriate, available transmission scenario. The transmission scenario may be simple or complex, depending on the system capabilities. The methods 400, 500 may be stored in computer-readable instructions stored in memory device 914 or in antenna diversity controller 906. In response to the selection, the modem 910 encodes the baseband data symbols as instructed by the antenna diversity controller 906. In one embodiment, the antenna diversity status is a FL diversity indicator indicating a MISO or a MIMO configuration. In an alternate embodiment, the antenna diversity status includes a RL diversity indicator indicating a SIMO or a MIMO configuration. In a simple form, the FL and RL diversity indicators may be one bit, wherein assertion indicates multiple antennas at the mobile user associated with the corresponding path, and negation indicates a single antenna. The antenna diversity status may include a variety of information, and may be sent as a message to the base station 900. For a given mobile user, the antenna diversity status may include the number of transmit antennas, the number of receive antennas, the reception diversity configuration, as well as other parameters of the mobile user. The base station 900 uses some or all of this information in selecting a transmission scenario for the mobile user, i.e., for a given communication link.

Once the base station has selected a transmission scenario, the antenna diversity controller 906 may send operating instructions to the mobile user. The base station may identify one of a set of predetermined scenarios to provide reception handling including, but not limited to, the form of equations used to generate the transmitted signals, selection decision criteria, number of transmitting antennas, etc. Similarly, the base station 900 may instruct the mobile user as to a transmission scenario for the RL. The confirmation may be in the form of a message transmitted to the mobile user, or may be broadcast to all users.

A variety of antenna diversity scenarios are available for processing communications to a receiver having only a single antenna. Embodiments may employ any number and/or combination of such scenarios. Similarly, negotiations between the transmitter and receiver for a given path of a communication link may be processed in a variety of ways. According to one embodiment, the antenna diversity status information is transmitted according to a predetermined format and/or protocol. An alternate embodiment allows the transmitter to query the receiver for individual diversity parameters, such as the number of receive antennas, the configuration and/or spacing of antennas, reception diversity handling specifics, etc. Still other embodiments allow the receiver to query the transmitter for specific information. Typically, antenna diversity negotiations are performed at initiation of a communication, however, alternate embodiments may allow adjustment during a communication, wherein the quality of the communication link channel degrades over time and environmental condition.

Implementation of spatial diversity in a wireless communication system requires consideration of those mobile stations that lack the capability of processing the multiple transmitted signals, e.g., a SISO unit. A brute force method assigns a carrier frequency to the SISO capable mobile station different from other carriers used in the system. A smart diversity solution, as described hereinabove, incorporates an algorithm or other method or technique that accommodates single receive antenna users in a mixed mode system. An alternate method placing less demand on the bandwidth usage of the system incorporates delay transmit diversity, wherein the signal intended for the SISO capable mobile station is transmitted via each antenna with a delay. This provides sufficient energy to prevent jamming the signal provided to the SISO user.

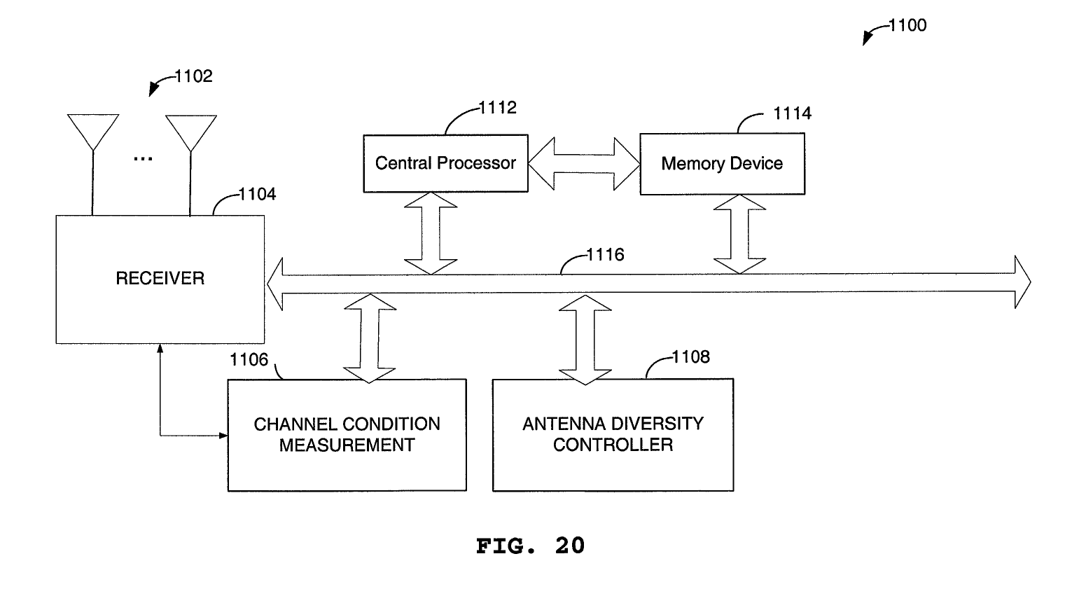

According to one embodiment of spatial diversity in a mixed mode system, illustrated in FIG. 19, a base station 1000 is adapted to communicate in a mixed mode system. For example, base station 1000 may communicate with mobile station 1012 that is SISO capable and base station 1000 may communicate with mobile station 1014 that is MIMO capable. The mobile station 1012 is specifically not capable of receiving signals from a transmitter employing transmit diversity. This implies that mobile station 1012 has a single receive antenna and is not adapted with any software, hardware, or other means for signals processed using transmit diversity. The mobile station 1012 is a basic SISO device. The MIMO capable mobile station 1014 may include a combination of multiple receive antennas, rake type receiver circuitry having the ability to combine multiple received signals, software and/or hardware for implementing a smart diversity method such as described hereinabove.

For optimum operation, the base station 1000 desires to transmit to MIMO capable mobile station 1014 using a spatial diversity or pure diversity technique, however, such transmissions from multiple antennas will introduce interference to SISO capable mobile station 1012. As discussed hereinabove the SNR of a received signal in a SISO communication, wherein the receiver includes a rake type receiver, is given as:

$${γ}_{SISO} = ( \frac{W φ {I}_{o}}{R} ) \cdot [ \frac{α}{η + β {I}_{0}} + \frac{β}{η + α {I}_{0}} ] . \qquad ( 5 )$$

The interference power in the denominator of the first term in square brackets of equation (5) is identically correlated with the signal power of the second term. Assuming the data rate and power allocation are matched appropriately, the interference power caused by the delay spread does not significantly contribute to the overall error rate. That is, the primary error event is when both paths fade into the noise.

When the transmitter introduces an additional transmit antenna to accommodate users employing MISO and/or MIMO, such a second transmit antenna results in a channel response to the SISO user of H₁(t)=h_{1,0}(t)+h_{1,1}(t−T), and the SNR at the rake type receiver output now becomes:

$${γ}_{mixed\_mode} = ( \frac{W φ {I}_{o}}{R} ) \cdot [ \frac{α}{η + β {I}_{0} + {I}_{1}} + \frac{β}{η + α {I}_{0} + {I}_{1}} ] . \qquad ( 6 )$$

Inspection of the SISO SNR expression of equation (6) shows that the power from the additional transmit antenna presents an independent fading interference term in the denominator of both terms in the brackets. In this case, the primary error event is the desired signal from antenna 0 fading relative to the interference power emitted from an additional antenna. As in mixed mode operation (e.g., one transmitter having communicating with a MIMO and/or MISO user and also with a SISO user), the interference power from the additional antennas can seriously degrade the performance of the SISO user.

In order for base station 1000 to transmit to both mobiles 1012 and 1014 using spatial diversity, i.e., multiple antennas, base station 1000 implements a delay in signals to the mobile station 1012 from multiple antennas. The provision of multiple copies of the signal intended for the SISO capable mobile station 1012 provides additional signal energy needed to prevent jamming caused by the transmissions from the multiple antennas.

As illustrated in FIG. 19, base station 1000 includes antennas 1008, 1010, wherein alternate embodiments may include any number of antennas. A first signal intended for MIMO capable mobile station 1012 is labeled SIGNAL 1, wherein this signal is provided to antenna 1008 of base station 1000. A second signal intended for the same MIMO capable mobile station is labeled SIGNAL 2, wherein this signal is provided to antenna 1010 of base station 1000.

The signal intended for SISO mobile station 1012 is labeled SIGNAL 3, wherein this signal is provided to antenna 1008 via node 1002. SIGNAL 3 is provided to antenna 1010 as a delayed signal, wherein SIGNAL 3 is provided to delay element 1004 and then to node 1006. For embodiments having more antennas than illustrated in FIG. 19, additional antennas may each have associated delays

The mobile station 1012 then receives the SIGNAL 3 transmitted from antenna 1008 and the delayed version of SIGNAL 3 from antenna 1010. The energy of the delayed version of SIGNAL 3 from antenna 1010 provides energy to balance the effects of other energies from other signals generated by the antenna 1008. The effective SNR at the output of the SISO RAKE receiver in this case for the two path channel model considered above is then given by:

$${γ}_{mixed\_mode} = ( \frac{W φ}{R} ) \cdot [ \frac{α {I}_{o}}{η + β {I}_{0} + {I}_{1}} + \frac{β {I}_{o}}{η + α {I}_{0} + {I}_{1}} + \frac{a {I}_{1}}{η + {I}_{0} + {bI}_{1}} + \frac{b {I}_{1}}{η + {I}_{0} + {aI}_{1}} ] , \\ where \\ a = E \{ {\vert {h}_{1 , 0} \vert}^{2} \} , \\ and \\ b = E \{ {\vert {h}_{1 , 1} \vert}^{2} \} . \qquad ( 9 )$$

According to one embodiment, a mobile station is capable of operating in a variety of transmission scenarios.

As illustrated in FIG. 20, mobile station 1100 includes a receive antenna array 1102 coupled to a receiver 1104. In one embodiment, the receiver 1104 is a transceiver. The receiver 1104 is then coupled to a channel quality measurement unit 1106. The mobile station 1100 measures a parameter associated with the channel quality, such as C/I, and makes a decision regarding receive processing based thereon. In general, the mobile station makes a data rate determination based on the channel quality, interference plus noise level and possibly other criteria. The mobile station conveys information to the base station(s) describing the preferred transmission mode. The decision determines which transmission scenario will be implemented by the antenna diversity controller 1108 for the channel.

Within mobile station 1100, modules communicate via a communication bus 1116. Instructions may be stored in a memory storage device, such as memory device 1114. A central processor 1112 controls operation within the mobile station 1100. In one embodiment, a look up table is provided in the memory device 1114, wherein entries associate a transmission scenario with multiple channel quality measures. Alternate embodiments may use other measures of channel quality, sufficient to provide information for determining a transmission scenario.

As described hereinabove, a base station often operates in a wireless communication system that may include a variety of different receivers, i.e. mobile stations, etc. To handle transmissions to a SISO receiver, the base station determines a transmission scenario. The transmission scenario may be a diversity technique, such as described by Walsh or Alamouti, as described hereinabove, a pure diversity approach, or a combination of these. Similarly, the base station may implement a transmission scenario that uses delays, as described hereinabove. In order to achieve a high data rate, alternate embodiments implement a spatial multiplexing scenario wherein redundant data is transmitted. The base station selects a transmission scenario based on the resources of the base station and the receiver. The resources of the receiver may be provided when the receiver registers with the base station, or the base station may query the receiver for such information. The base station then implements a scenario.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a Digital Signal Processor, DSP, an Application Specific Integrated Circuit ASIC, a Field Programmable Gate Array FPGA or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in Random Access Memory, RAM, flash memory, Read Only Memory, ROM, Erasable Programmable ROM, EPROM, Electrically Erasable Programmable ROM, EEPROM, registers, hard disk, a removable disk, a Compact Disk or CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A base station apparatus comprising:
an antenna array; and
a diversity controller coupled to the antenna array, operative for determining a transmission scenario based on the configuration of a given communication link.

2. An apparatus as in claim 1, wherein the diversity controller is operative to query a mobile station for diversity capability of the mobile station to establish a first communication link with the mobile station.

3. An apparatus as in claim 2, wherein the diversity controller is operative to determine the transmission scenario according to the antenna configuration of the mobile station and the antenna configuration of the base station.

4. An apparatus as in claim 3, wherein if the mobile station has a single antenna the diversity controller is operative to transmit to the mobile station on a single antenna.

5. An apparatus as in claim 3, further comprising:
a delay element coupled between a first antenna element and a second antenna element of the antenna array,
wherein if the mobile station has a single antenna the apparatus is operative to transmit to the mobile station using the first and second antenna elements.

6. An apparatus as in claim 3, wherein:
the antenna array comprises a first antenna element and a second antenna element,
during a first time period the first antenna element transmits a first signal and the second antenna element transmits a second signal, and
during a second time period the first antenna transmits a third signal that is a function of the second signal and the second antenna transmits a fourth signal that is a function of the first sign.

7. An apparatus as in claim 3, further comprising:
a first coding unit; and
a switching means for coupling the first coding unit to the antenna array.

8. An apparatus as in claim 1, wherein for a multiple input multiple output capable receiver the transmission scenario is determined as a function of a channel quality metric.

9. An apparatus as in claim 1, wherein the transmission scenario is determined as a function of receiver capability.

10. A base station apparatus comprising:
an antenna array;
a control processor for processing computer-readable instructions; and
a memory storage device coupled to the control processor, operative to store a plurality of computer-readable instructions, comprising:
a first set of instructions for requesting antenna diversity status of the first communication link;
a second set of instructions for determining a first transmission scenario of the first communication link in response to the antenna diversity status; and
a third set of instructions for applying the first transmission scenario to the first communication link.

11. An apparatus as in claim 10, wherein for a multiple input multiple output capable receiver the transmission scenario is determined as a function of the channel quality.

12. An apparatus as in claim 10, wherein antenna diversity status comprises the number of receive antennas at a receiver of the first communication link.

13. A method for communication in a wireless communication system, the method comprising:
receiving antenna diversity status information for a first communication link; and
determining a configuration of the first communication link in response to the antenna diversity status information; and
applying a transmission scenario to the first communication link.

14. A method as in claim 13, further comprising:
receiving antenna diversity status information for a second communication link;
determining a second configuration of the second communication link in response to the antenna diversity status information; and
applying a second transmission scenario to the second communication links.

15. A method as in claim 14, wherein if the first configuration is a single receive antenna configuration, and the second configuration is a multiple receive antenna configuration, the transmission scenario applies a delay to signals for the first communication link.

16. A computer readable media embodying a method for determining a transmission scenario in a wireless communication system, the method comprising:
querying multiple mobile users for antenna diversity status;
receiving antenna diversity status information from at least one of the mobile users; and
applying a transmission scenario consistent with the antenna diversity status information.

17. A mobile station apparatus comprising:
a channel quality measurement unit operative to determine a channel quality; and
a diversity controller coupled to the channel quality measurement unit, operative for determining a transmission scenario based on the channel quality.

18. A mobile station apparatus as in claim 17, wherein the channel quality is a function of a ratio of carrier to interference of received signals.

19. A mobile station apparatus as in claim 17, further comprising:
a receiver coupled to channel quality measurement unit and the diversity controller,
wherein the mobile station apparatus configures the receiver consistent with the transmission scenario.

20. A method for receiving communications in a wireless communication system, comprising:
receiving a communication signal;
measuring a channel quality based on the received communication signal; and
determining a transmission scenario based on the channel quality.

21. A wireless communication system, comprising:
transmit antenna means;
receive antenna means operative for receiving communications from the transmit antenna means; and
a diversity controller coupled to the transmit antenna means, operative for determining a transmission scenario based on the configuration of a given communication link.
